(19) United States
(12) Patent Application Publication
(10) Pub. No.: US 2024/0292441 A1
(43) Pub. Date: Aug. 29, 2024

(54) PHYSICAL SIDELINK FEEDBACK CHANNEL RESOURCE CONFIGURATION METHOD,TERMINAL, AND NETWORK SIDE DEVICE

(71) Applicant: VIVO MOBILE COMMUNICATION CO., LTD., Dongguan (CN)

(72) Inventors: Shixiao LIU, Dongguan (CN); Zichao JI, Dongguan (CN); Huan WANG, Dongguan (CN)

(73) Assignee: VIVO MOBILE COMMUNICATION CO., LTD., Dongguan (CN)

(21) Appl. No.: 18/657,737

(22) Filed: May 7, 2024

Related U.S. Application Data
(63) Continuation of application No. PCT/CN2022/131195, filed on Nov. 10, 2022.

(30) Foreign Application Priority Data
Nov. 10, 2021 (CN) 202111328245.3

(51) Int. Cl. H04W 72/40; H04W 28/26; H04W 72/02; H04W 72/25; H04W 72/563

(52) U.S. Cl. CPC H04W 72/40; H04W 28/26; H04W 72/02; H04W 72/25; H04W 72/563

(57) ABSTRACT

A Physical Sidelink Feedback CHannel (PSFCH) resource configuration method, a terminal, and a network side device are provided. The PSFCH resource configuration method includes: sending, by a first communication device, first signaling to a second communication device by using a PSFCH resource according to a first rule, where the first signaling is used to instruct the second communication device to perform resource reselection, and the first signaling carries at least one of the following information: information about whether to perform resource reselection; collision type information of resource collision; location information of resource collision; time validity feature information of resource collision; collision overlapping degree information of at least one collision resource; transmission type information of resource collision; necessity degree information of resource reselection; quantity or proportion information of resource collision; service priority information corresponding to colliding resources; or resource reselection priority information.

### CROSS-REFERENCE TO RELATED APPLICATIONS

This application is a continuation of International Application No. PCT/CN2022/131195, filed on Nov. 10, 2022, which claims priority to Chinese Patent Application No. 202111328245.3, filed Nov. 10, 2021. The entire contents of each of the above-identified applications are expressly incorporated herein by reference.

### TECHNICAL FIELD

This application pertains to the field of communication technologies, and specifically to a physical sidelink feedback channel resource configuration method, a terminal, and a network side device.

### BACKGROUND

In a SideLink (SL) resource selection enhancement solution, interference detection or resource reservation collision detection may be considered on a Receive end device (RX UE) or another terminal side. If it is detected that a resource reserved by a Transmit end device (TX UE) collides with a resource reserved by another UE, signaling is sent to the TX UE to instruct to trigger the TX UE to perform resource reselection. In a related technology, a Physical Sidelink Feedback CHannel (PSFCH) resource is used to instruct the TX UE to perform resource reselection. However, problems such as how to use the PSFCH resource to indicate resource reselection, how to determine a resource occupied by resource reselection information, and a resource reuse manner are still to be resolved.

### SUMMARY

Embodiments of this application provide a physical sidelink feedback channel resource configuration method, a terminal, and a network side.

According to a first aspect, a physical sidelink feedback channel resource configuration method is provided and is applied to a first communication device, and the method includes:
the first communication device sends first signaling to a second communication device by using a physical sidelink feedback channel PSFCH resource according to a first rule, where the first signaling is used to instruct the second communication device to perform resource reselection, and the first signaling carries at least one of the following information: information about whether to perform resource reselection; collision type information of resource collision; location information of resource collision; time validity feature information of resource collision; collision overlapping degree information of at least one colliding resource; transmission type information of resource collision; necessity degree information of resource reselection; quantity or proportion information of resource collision; service priority information corresponding to colliding resources; or resource reselection priority information.

According to a second aspect, a physical sidelink feedback channel resource configuration method is provided and is applied to a second communication device, and the method includes:
the second communication device receives first signaling on a physical sidelink feedback channel PSFCH resource, where the first signaling is used to instruct the second communication device to perform resource reselection, and the first signaling carries at least one of the following information: information about whether to perform resource reselection; collision type information of resource collision; location information of resource collision; time validity feature information of resource collision; collision overlapping degree information of at least one colliding resource; transmission type information of resource collision; necessity degree information of resource reselection; quantity or proportion information of resource collision; service priority information corresponding to colliding resources; or resource reselection priority information.

According to a third aspect, a physical sidelink feedback channel resource configuration apparatus is provided, and the apparatus includes:
a first sending unit, configured to send first signaling to a second communication device by using a physical sidelink feedback channel PSFCH resource according to a first rule, where the first signaling is used to instruct the second communication device to perform resource reselection, and the first signaling carries at least one of the following information: information about whether to perform resource reselection; collision type information of resource collision; location information of resource collision; time validity feature information of resource collision; collision overlapping degree information of at least one colliding resource; transmission type information of resource collision; necessity degree information of resource reselection; quantity or proportion information of resource collision; service priority information corresponding to colliding resources; or resource reselection priority information.

According to a fourth aspect, a physical sidelink feedback channel resource configuration apparatus is provided, and the apparatus includes:
a first receiving unit, configured to receive first signaling on a physical sidelink feedback channel PSFCH resource, where the first signaling is used to instruct the second communication device to perform resource reselection, and the first signaling carries at least one of the following information: information about whether to perform resource reselection; collision type information of resource collision; location information of resource collision; time validity feature information of resource collision; collision overlapping degree information of at least one colliding resource; transmission type information of resource collision; necessity degree information of resource reselection; quantity or proportion information of resource collision; service priority information corresponding to colliding resources; or resource reselection priority information.

According to a fifth aspect, a first communication device is provided. The first communication device includes a processor, a memory, and a program or an instruction that is stored in the memory and that can run the processor, and when the program or the instruction is executed by the processor, steps of the physical sidelink feedback channel resource configuration method according to the first aspect are implemented.

According to a sixth aspect, a first communication device is provided, including a processor and a communication interface. The processor is configured to send first signaling to a second communication device by using a physical sidelink feedback channel PSFCH resource according to a first rule, where the first signaling is used to instruct the second communication device to perform resource reselection, and the first signaling carries at least one of the following information: information about whether to perform resource reselection; collision type information of resource collision; location information of resource collision; time validity feature information of resource collision; collision overlapping degree information of at least one colliding resource; transmission type information of resource collision; necessity degree information of resource reselection; quantity or proportion information of resource collision; service priority information corresponding to colliding resources; or resource reselection priority information.

According to a seventh aspect, a second communication device is provided. The second communication device includes a processor, a memory, and a program or an instruction that is stored in the memory and that can run on the processor, and when the program or the instruction is executed by the processor, steps of the physical sidelink feedback channel resource configuration method according to the second aspect are implemented.

According to an eighth aspect, a second communication device is provided, including a processor and a communication interface. The communication interface is configured to receive first signaling on a physical sidelink feedback channel PSFCH resource, where the first signaling is used to instruct the second communication device to perform resource reselection, and the first signaling carries at least one of the following information: information about whether to perform resource reselection; collision type information of resource collision; location information of resource collision; time validity feature information of resource collision; collision overlapping degree information of at least one colliding resource; transmission type information of resource collision; necessity degree information of resource reselection; quantity or proportion information of resource collision; service priority information corresponding to colliding resources; or resource reselection priority information.

According to a ninth aspect, a readable storage medium is provided. The readable storage medium stores a program or an instruction, and when the program or the instruction is executed by a processor, steps of the physical sidelink feedback channel resource configuration method according to the first aspect are implemented, or steps of the physical sidelink feedback channel resource configuration method according to the second aspect are implemented.

According to a tenth aspect, a chip is provided. The chip includes a processor and a communication interface, the communication interface is coupled to the processor, and the processor is configured to run a program or an instruction to implement the physical sidelink feedback channel resource configuration method according to the first aspect or the physical sidelink feedback channel resource configuration method according to the second aspect.

According to an eleventh aspect, a computer program/program product is provided. The computer program/program product is stored in a non-transitory storage medium, and the program/program product is executed by at least one processor to implement steps of the physical sidelink feedback channel resource configuration method according to the first aspect or steps of the physical sidelink feedback channel resource configuration method according to the second aspect.

### BRIEF DESCRIPTION OF DRAWINGS

FIG. 1 is a block diagram of a wireless communication system to which embodiments of this application can be applied;

FIG. 2 is a first flowchart of a physical sidelink feedback channel resource configuration method according to an embodiment of this application;

FIG. 3 is a first schematic diagram of indication resource collision according to an embodiment of the application;

FIG. 4 is a second schematic diagram of indication resource collision according to an embodiment of the application;

FIG. 5 is a third schematic diagram of indication resource collision according to an embodiment of this application;

FIG. 6 is a block diagram of state configuration in a cyclic prefix set according to an embodiment of this application;

FIG. 7 is a second flowchart of a physical sidelink feedback channel resource configuration method according to an embodiment of this application;

FIG. 8 is a first diagram of a structure of a physical sidelink feedback channel resource configuration apparatus according to an embodiment of this application;

FIG. 9 is a second block diagram of a physical sidelink feedback channel resource configuration apparatus according to an embodiment of this application;

FIG. 10 is a block diagram of a communication device according to an embodiment of this application;

FIG. 11 is a block diagram of a first communication device for implementing embodiments of this application;

FIG. 12 is a block diagram of a first communication device according to an embodiment of this application;

FIG. 13 is a block diagram of a second communication device for implementing embodiments of this application; and

FIG. 14 is a block diagram of a second communication device according to an embodiment of this application.

### DETAILED DESCRIPTION

The following describes embodiments of this application with reference to accompanying drawings in embodiments of this application. The described embodiments are some but not all of embodiments of this application. All other embodiments obtained by a person of ordinary skill in the art based on the embodiments of this application shall fall within the protection scope of this application.

The terms “first,” “second,” and the like in this specification and claims of this application are used to distinguish between similar objects instead of describing a specific order or sequence. It should be understood that, the terms used in such a way is interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the description and the claims, “and/or” represents at least one of connected objects, and a character “/” generally represents an “or” relationship between associated objects.

It should be noted that, the technologies described in the embodiments of this application are not limited to a Long Term Evolution (LTE)/LTE-Advanced (LTE-A) system, and can also be used in other wireless communication systems such as Code Division Multiple Access (CDMA), Time Division Multiple Access (TDMA), Frequency Division Multiple Access (FDMA), Orthogonal Frequency Division Multiple Access (OFDMA), Single-Carrier Frequency-Division Multiple Access (SC-FDMA), and another system. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and the NR terminology is used in most of the following description, although these technologies can also be applied to applications other than the NR system application, such as the 6th Generation (6G) communication system.

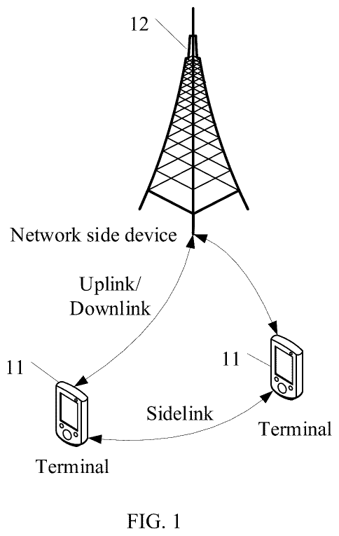

FIG. 1 is a structural diagram of a wireless communication system to which embodiments of this application can be applied. The wireless communication system includes a terminal 11 and a network side device 12. The terminal 11 may also be referred to as a terminal device or User Equipment (UE). The terminal 11 may be a mobile phone, a tablet personal computer, a laptop computer that is alternatively referred to as a notebook computer, a Personal Digital Assistant (PDA), a palm computer, a netbook, an Ultra-Mobile Personal Computer (UMPC), a Mobile Internet Device (MID), an Augmented Reality (AR)/Virtual Reality (VR) device, a robot, a wearable device, Vehicle-mounted User Equipment (VUE), Pedestrian User Equipment (PUE), or a smart home device (a home device with a wireless communication function, such as a refrigerator, a television, a washing machine, or furniture). The wearable device includes a smart watch, a smart band, a smart headset, smart glasses, smart jewelry (a smart bangle, a smart bracelet, a smart ring, a smart necklace, a smart anklet bracelet, a smart anklet, or the like), a smart wrist strap, a smart dress, a game console, and the like. It should be noted that a specific type of the terminal 11 is not limited in the embodiments of this application. The network side device 12 may be a base station or a core network. The base station may be referred to as a NodeB, an evolved NodeB, an access point, a control node, a Base Transceiver Station (BTS), a radio base station, a radio transceiver, a Basic Service Set (BSS), an Extended Service Set (ESS), a NodeB, an evolved NodeB (eNB), a home NodeB, a home evolved NodeB, a WLAN access point, a WIFI node, a Transmitting Receiving Point (TRP), or another suitable term in the field provided that a same technical effect is achieved. The base station is not limited to a specific technical term. It should be noted that, in the embodiments of this application, only a base station in an NR system is used as an example, but a specific type of the base station is not limited.

There are two NR SL resource allocation manners: One is based on base station scheduling (mode 1), and the other is based on autonomous resource selection of UE (mode 2). With regard to the resource allocation mode based on base station scheduling, a sidelink resource used by the UE for data transmission is determined by the base station, and a transmit terminal TX UE is notified by downlink signaling; with regard to the resource allocation mode based on autonomous resource selection of the UE, the UE selects an available transmission resource from a (pre-) configured resource pool, and before resource selection, the UE performs channel sensing, selects a resource set with less interference based on a channel sensing result, and then randomly selects a resource for transmission from the resource set.

A specific working manner in mode 2 is as follows. (1) After resource selection is triggered, the TX UE first determines a resource selection window, where a lower boundary of the resource selection window is in time T1 after the resource selection is triggered, and an upper boundary of the resource selection window is in time T2 after the resource selection is triggered, where T1 is selected from a range [T1_min, T1_max] in a UE-implemented manner, T2 is a value selected from a packet delay budget PDB (packet delay budget) transmitted in a Transport Block (TB) in the UE-implemented manner, and T2 is not earlier than T1. (2) Before resource selection, the UE needs to determine a candidate resource set for resource selection, where a quantity of candidate resource subchannels is determined by a Media Access Control (MAC) layer. The UE compares a Reference Signal Received Power (RSRP) measurement value (for example, estimated by monitoring a Physical Sidelink Control CHannel (PSCCH)/Physical Sidelink Shared CHannel (PSSCH)) estimated on a resource in the resource selection window with a corresponding RSRP threshold, and if the RSRP is greater than the RSRP threshold, the resource is ruled out and cannot be included in the candidate resource set. After the resource ruled out, remaining resources in the resource selection window form the candidate resource set. Resources in the candidate resource set account for at least x % of resources in the resource selection window. If the resources in the candidate resource set account for less than x % of the resources in the resource selection window, the RSRP threshold needs to be increased according to a step-by-step value (3 dB), and then the resource is ruled out until no less than x % of the resources can be selected. In addition, the RSRP comparison is related to a priority of a to-be-transmitted TB and a priority value demodulated on the PSCCH, and a specific process is not described. (3) After the candidate resource set is determined, the UE randomly selects a transmission resource from the candidate resource set, and a quantity of selected resources is determined according to a decision of the MAC layer. In addition, the UE may reserve a transmission resource for next transmission in this transmission.

In Rel-16 NR SL, the TX UE may reserve/indicate a resource allocated by the TX UE (the reservation includes periodic reservation and aperiodic reservation), and the reserved resource may be used for future PSCCH/PSSCH transmission.

The aperiodic reservation/indication may be implemented based on a time resource assignment field in Sidelink Control Information (SCI) (resources of at least 1 to 32 slots are indicated). The reserved resource can be used at least for transmission of a same TB.

The periodic reservation/indication may be implemented by using a resource reservation period field in the SCI, and periodic resources reserved in a current period may be used for transmission of a next TB. Herein, a frequency domain resource that appears periodically may be referred to as a periodic resource of the resource.

In a sidelink resource selection enhancement solution, interference detection or resource reservation collision detection may be considered on a receive terminal RX UE side or another terminal side. If it is detected that a resource reserved by the TX UE collides with a resource reserved by another UE, signaling is sent to the TX UE to instruct to trigger the TX UE to perform resource reselection. Currently, the 3rd Generation Partnership Project (3GPP) has agreed to send signaling by using a Physical Sidelink Feedback CHannel (PSFCH) channel resource to instruct to trigger the TX UE to perform resource reselection. However, problems such as how to use the PSFCH resource to instruct to perform resource reselection, information content carried in the resource reselection indication information, an expressed meaning, how to determine a resource occupied by the resource reselection indication information, and a resource reuse manner are still to be resolved.

A physical sidelink feedback resource configuration method provided in the embodiments of this application is described below by using specific embodiments and application scenarios thereof with reference to the accompanying drawings.

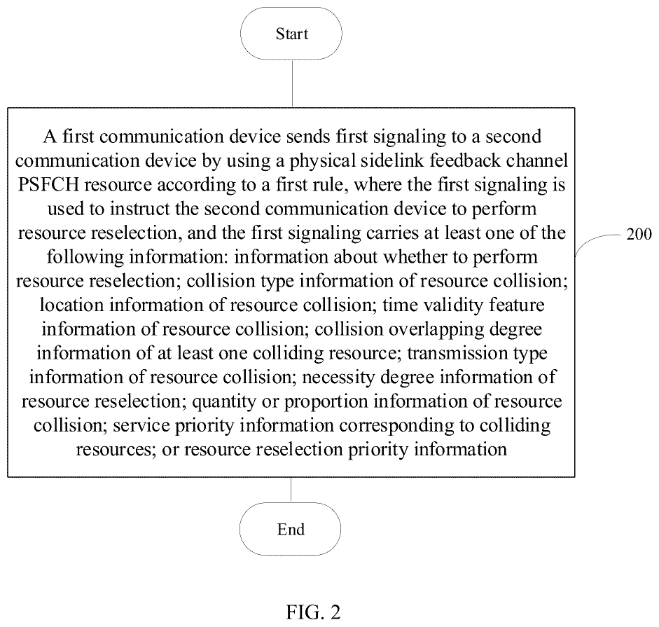

FIG. 2 is a first schematic flowchart of a physical sidelink feedback channel resource configuration method according to an embodiment of this application. As shown in FIG. 2, the method includes the following step:

Step 200: A first communication device sends first signaling to a second communication device by using a PSFCH resource according to a first rule, where the first signaling is used to instruct the second communication device to perform resource reselection.

It should be noted that, in this embodiment of this application, the first communication device may be a terminal, a control node, or a network side device, the second communication device may be a terminal, a control node, or a network side device, and the control node may be a base station, a micro base station, a RoadSide Unit (RSU), UE capable of scheduling, or the like.

The second communication device is a data transmit end device.

The first communication device may be a data transmit/receive end device of the second communication device, or may not be a data transmit/receive end device of the second communication device.

In some embodiments, the first rule includes at least one of the following:
the first communication device detects that a resource selected or reserved by the second communication device collides with the resource selected or reserved by the first communication device;
the first communication device detects that a resource selected or reserved by a third communication device collides with a resource selected or reserved by the second communication device;
the first communication device detects that an uplink transmission resource of the first communication device collides with a resource selected or reserved by the second communication device; or
the first communication device detects that an uplink transmission resource of a third communication device collides with a resource selected or reserved by the second communication device; where
the third communication device is another communication device except the first communication device.

It may be understood that when the first communication device detects at least one of the foregoing four resource collision cases, the first communication device sends the first signaling to the second communication device by using the PSFCH resource, to trigger the second communication device to perform resource reselection.

It should be noted that in this embodiment of this application, the resource collision includes at least one of the following:
time domain resources partially or entirely overlap; or
frequency domain resources partially or entirely overlap.

In sidelink PSFCH transmission of R16, an amount of information carried on one PSFCH is only 1 bit, and expressed information is an ACKnowledgment (ACK) or a Non-ACKnowledgment (NACK). Transmission of each PSFCH occupies one Physical Resource Block (PRB). In terms of content and an expressed meaning of signaling used to indicate resource reselection, information of only 1 bit may be carried to indicate whether to perform retransmission. An advantage of this manner is that signaling overheads are extremely small, but an extremely small amount of information is carried.

Certainly, it may be considered to add some additional signaling overheads, for example, 1 to 2 bits are added, and a retransmission indication carries some other information, such as a detected collision type and the necessity of reselection. In a case that little signaling overheads are added, the second communication device can be effectively helped to perform necessary resource reselection, and some unnecessary resource reselection is avoided, and therefore, resource reselection efficiency can be improved, and excessive reselection overheads can be avoided.

Information content indicated by the first signaling is defined in this embodiment of this application.

The first signaling carries at least one of the following information:
information about whether to perform resource reselection;
collision type information of resource collision;
location information of resource collision;
time validity feature information of resource collision;
collision overlapping degree information of at least one colliding resource;
transmission type information of resource collision;
necessity degree information of resource reselection;
quantity or proportion information of resource collision;
service priority information corresponding to colliding resources; or
resource reselection priority information.

In an implementation, resource reselection information and resource non-reselection information may be separately indicated by using two code points.

In some implementations, the collision type information of the resource collision includes at least one of the following:
collision caused by entire or partial overlapping between the resource selected or reserved by the second communication device and the resource selected or reserved by the third communication device;
collision caused by entire or partial overlapping between a PSFCH resource associated with the resource selected or reserved by the second communication device and a PSFCH resource associated with the resource selected or reserved by the third communication device, where the collision is resource collision of a half-duplex type that is caused because when the PSFCH resource associated with the resource selected or reserved by the second communication device and the PSFCH resource associated with the resource selected or reserved by the third communication device are in a same slot or sub-frame, the third communication device needs to receive, on a PSFCH of the slot or the sub-frame, a Hybrid Automatic Repeat reQuest (HARQ) feedback from another communication device, and consequently, a HARQ cannot be fed back to the second communication device;
collision caused by entire or partial overlapping between a PSFCH resource associated with the resource selected or reserved by the second communication device and the resource selected or reserved by the third communication device;
collision caused by entire or partial overlapping between the resource selected or reserved by the second communication device and a PSFCH resource associated with the resource selected or reserved by the third communication device;
collision caused by entire or partial overlapping between the resource selected or reserved by the second communication device and the uplink transmission resource of the third communication device, where the collision is resource collision of a half-duplex type that is caused because when the resource selected or reserved by the second communication device and the uplink transmission resource of the third communication device are in a same slot or sub-frame, the third communication device needs to send uplink data transmission in the slot or sub-frame and consequently, data sent by the second communication device cannot be received;
collision caused by entire or partial overlapping between a PSFCH resource associated with the resource selected or reserved by the second communication device and the uplink transmission resource of the third communication device, where the collision is resource collision of a half-duplex type that is caused because when the PSFCH resource associated with the resource selected or reserved by the second communication device and the uplink transmission resource of the third communication device are in a same slot or sub-frame, the third communication device needs to send uplink data transmission in the slot or sub-frame, and consequently, a HARQ cannot be fed back to the second communication device;
collision caused by entire or partial overlapping between the resource selected or reserved by the second communication device and a resource location selected or reserved by the first communication device to perform SL transmission;
collision caused by entire or partial overlapping between the resource selected or reserved by the second communication device and a resource location at which the first communication device performs UpLink (UL) transmission, where the collision is resource collision of a half-duplex type that is caused because when the resource selected or reserved by the second communication device and an uplink transmission resource of the first communication device are in a same slot or sub-frame, the first communication device needs to send uplink data transmission in the slot or sub-frame, and consequently, data sent by the second communication device cannot be received.
collision caused by entire or partial overlapping between a PSFCH resource associated with the resource selected or reserved by the second communication device and the resource selected or reserved by the first communication device;
collision caused by entire or partial overlapping between a PSFCH resource associated with the resource selected or reserved by the second communication device and a PSFCH resource associated with the resource selected or reserved by the first communication device, where the collision is resource collision of a half-duplex type that is caused because when the PSFCH resource associated with the resource selected or reserved by the second communication device and the PSFCH resource associated with the resource selected or reserved by the first communication device are in a same slot or sub-frame, the first communication device needs to receive, on a PSFCH of the slot or the sub-frame, a HARQ feedback from another communication device, and consequently, a HARQ cannot be fed back to the second communication device;
collision caused by entire or partial overlapping between a PSFCH resource associated with the resource selected or reserved by the second communication device and an uplink UL transmission resource of the first communication device, where the collision is resource collision of a half-duplex type that is caused because when the PSFCH resource associated with the resource selected or reserved by the second communication device and the uplink transmission resource of the first communication device are in a same slot or sub-frame, the first communication device needs to send uplink data transmission in the slot or sub-frame, and consequently, a HARQ cannot be fed back to the second communication device; or
collision caused by entire or partial overlapping between the resource selected or reserved by the second communication device and a PSFCH resource associated with the resource selected or reserved by the first communication device.

It should be noted that the foregoing twelve collision types may be further classified into two types. One type is that the resource reserved or selected by the second communication device is occupied by another communication device, that is, collision caused by partial overlapping or entire overlapping between resources selected or reserved by the second communication device and the another communication device. The other type is half-duplex collision between the resource reserved or selected by the second communication device or the PSFCH resource associated with the reserved or selected resource and sending or receiving behavior of another communication device.

In some implementations, the location information of the resource collision includes at least one of the following:
some/all resources in the first N/K periods in the periodically reserved resources;
an M^{th} resource in the first N/K periods in the periodically reserved resources;
first/last M resources in the first N/K periods in the periodically reserved resources;
an M^{th} resource in aperiodically reserved resources;
all or some resources in aperiodically reserved resources; or
first/last M resources in aperiodically reserved resources; where
N, K, and M are positive integers.

In some implementations, the time validity feature information of the resource collision includes at least one of the following:
there is resource collision in a P^{th} period in periodically reserved resources;
there is resource collision in the first P periods in periodically reserved resources;
there is resource collision in the last P periods in periodically reserved resources;
there is a conflict in first preset duration after a current moment in periodically reserved resources;
there is a conflict in first preset duration after a current moment in aperiodically reserved resources;
there is resource collision in the first Q reserved resources in aperiodically reserved resources;
there is resource collision in the last Q reserved resources in aperiodically reserved resources; or
there is resource collision in a Q^{th} reserved resource in aperiodically reserved resources; where
both P and Q are positive integers.

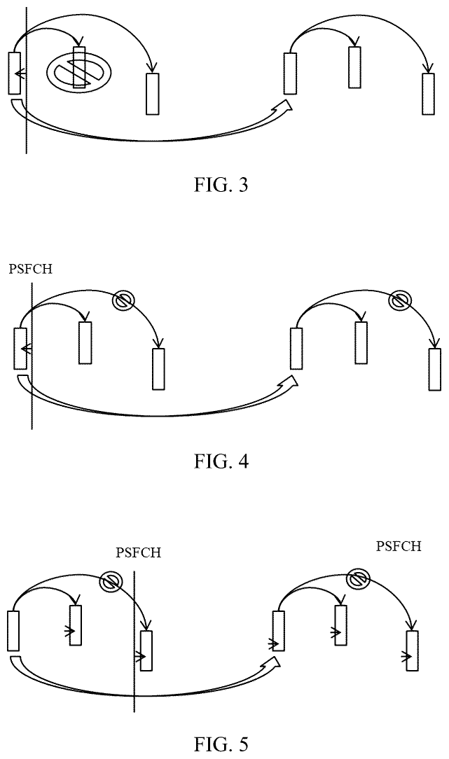

For example, in a scenario of periodic reservation, two or three resources may be reserved in a period. If in this case, the first communication device detects that the resource reserved by the second communication device collides with a resource reserved by another communication device, but because a resource reserved in a second period or several future periods is excessively far from a current moment, although collision can be detected at present, as a channel changes, a future situation is not particularly clear, and therefore, only corresponding colliding resources in a current nearest P periods can be indicated for reselection, and another resource is not used for reselection. FIG. 3 is a schematic diagram of resource collision indication according to an embodiment of this application. To be specific, if resource collision is detected on a second resource in a period, resource reselection is performed on only a second resource in the latest period.

In some implementations, the collision overlapping degree information of at least one colliding resource includes at least one of the following:
partial overlapping or entire overlapping;
a quantity of overlapping subchannels, a quantity of slots, a quantity of Physical Resource Blocks (PRBs), or a quantity of symbols;
a proportion of overlapping resources to a total quantity of resources reserved by the second communication device; or
a proportion of overlapping resources to current colliding resources reserved by the second communication device.

In some implementations, the transmission type information of the resource collision includes at least one of the following:
colliding resources are used for unicast transmission, multicast transmission, or broadcast transmission;
colliding resources are used to send data to a specific communication device or a specific group; or
colliding resources are used to send data to a control node.

In some implementations, the necessity degree information of the resource collision includes at least one of the following:
resource reselection that is necessary, that is suggested to be performed, that is suggested not to be performed, or that is unnecessary; or
a weight coefficient, where the weight coefficient is used to indicate a necessity degree of resource reselection.

In an implementation, the weight coefficient is represented by a percentage, and a larger percentage indicates a higher or lower necessity degree of resource reselection.

In some implementations, the quantity or proportion information of the resource collision includes at least one of the following:
a quantity of colliding resources, where the quantity of colliding resources includes a quantity of colliding slots, subchannels, symbols, or physical resource blocks;
a proportion of colliding resources to a total quantity of resources reserved by the second communication device or a total quantity of resources reserved by the second communication device in at least one period;
a quantity of colliding resources in second preset duration; or
a proportion of colliding resources in second preset duration to a total quantity of resources reserved by the second communication device in the second preset duration or a total quantity of resources reserved by the second communication device in at least one period in the second preset duration.

The total quantity of reserved resources includes a total quantity of reserved slots, subchannels, symbols, or physical resource blocks.

In some implementations, the service priority information corresponding to colliding resources includes at least one of the following:
service priority information of a conflicting source device corresponding to the colliding resources;
a difference between a service priority of the second communication device and a service priority of a conflicting source device on the colliding resources or an absolute value of the difference; or
a relationship between a service priority of the second communication device and a service priority of a conflicting source device on the colliding resources; where
the conflicting source device is the first communication device or the third communication device.

For example, it may be indicated that a service priority of the second communication device is lower/higher than/equal to a priority of the conflicting source device on the colliding resource.

In some implementations, the resource reselection priority information may include a priority coefficient and a priority weight.

It should be noted that information content carried in the foregoing first signaling provided in this embodiment of this application may be used separately or in a mixed manner.

In this embodiment of this application, resource reselection indication signaling is transmitted by using a PSFCH, so that a second communication device can be effectively helped in performing necessary resource reselection, and avoiding some unnecessary resource reselection, and therefore, resource reselection efficiency can be improved, transmission efficiency in a sidelink system can be improved, and system performance can be improved.

The PSFCH is in a fixed association relationship with a Physical Sidelink Control CHannel (PSCCH)/Physical Sidelink Shared CHannel (PSSCH), and flexibility of PSFCH transmission is limited. Therefore, it is possible that the determined PSFCH resource cannot be used to indicate resource reselection.

In addition, there may be a case in which a plurality of communication devices simultaneously send a resource reselection indication. Therefore, a configuration manner of the PSFCH resource used for transmission of the resource reselection indication needs to be specified.

In some implementations, before step 200, the method further includes:
determining a time-frequency domain resource of the PSFCH resource.

Configuration methods of the PSFCH resource used for transmission of the resource reselection indication that are provided in this embodiment of this application are described below.

### 1. Time Domain Resource of a PSFCH

In some implementations, the PSFCH resource occupies one or two symbols in time domain.

In a case that the PSFCH resource occupies two symbols in time domain, resources on the symbols are used to transmit different information.

In some embodiments, a time domain resource location of the PSFCH resource is determined in at least one of the following manners:

Manner 1: The time domain resource location of the PSFCH resource is determined based on a first slot/sub-frame in which Sidelink Control Information (SCI) sent by the second communication device to indicate a reserved resource is located.

The determining the time domain resource location of the PSFCH resource based on a first slot/sub-frame in which SCI sent by the second communication device to indicate a reserved resource is located includes at least one of the following:
in a case that there is a first PSFCH resource in the first slot/sub-frame, determining to transmit the first signaling by using the first PSFCH resource;
in a case that there is no PSFCH resource in the first slot/sub-frame, determining to transmit the first signaling by using a PSFCH resource that is nearest to the first slot/sub-frame;
transmitting the first signaling by using a PSFCH resource in an L^{th} slot/sub-frame after the first slot;
transmitting the first signaling by using a PSFCH resource that is nearest to an L^{th} slot/sub-frame after the first slot, where the nearest PSFCH resource is before or after the L^{th} slot/sub-frame after the first slot; or
transmitting the first signaling by using at least one PSFCH resource in third preset duration after the first slot; where
L is a positive integer.

The SCI sent by the second communication device to indicate a reserved resource may be understood as that the SCI is used to indicate the resource reserved by the second communication device.

For example, when the first communication device detects that a reserved resource indicated by the SCI sent by the second communication device collides with a resource reserved by another communication device, only a slot in which the first or second resource reserved by the second communication device is located is used, and one resource is selected from a PSFCH channel that is the closest to the first communication device to transmit the reselection indication information. FIG. 4 is a second schematic diagram of resource collision indication according to an embodiment of this application.

Manner 2: The time domain resource location of the PSFCH resource is determined based on a second slot/sub-frame in which a colliding resource reserved by the second communication device is located.

The determining the time domain resource location of the PSFCH resource based on a second slot/sub-frame in which a colliding resource reserved by the second communication device is located includes at least one of the following:
transmitting the first signaling on a PSFCH resource in U slots/sub-frames before a second slot in which at least one colliding resource is located or in fourth preset duration;
transmitting the first signaling on a PSFCH resource that is nearest to a second slot in which at least one colliding resource is located;
transmitting the first signaling on a PSFCH resource that is before or after H slots/sub-frames before a second slot in which at least one colliding resource is located; or
selecting X PSFCH resources from R slots/sub-frames in R slots/sub-frames before a second slot in which at least one colliding resource is located or in fifth preset duration as a second PSFCH resource, and transmitting the first signaling on the second PSFCH resource; where
U, H, R, and X are positive integers.

It may be understood that, a slot in which the colliding resource is located separately corresponds to one PSFCH resource, the PSFCH resource is located in N slots/a period of time before the slot in which the colliding resource is located, and one reselection indication is transmitted on a corresponding PSFCH before resource collision. Alternatively, a slot in which the colliding resource is located separately corresponds to one PSFCH resource, and one PSFCH resource is selected, where the PSFCH resource is located in N slots/a period of time before the slot in which the colliding resource is located, and one reselection indication is transmitted on a corresponding PSFCH before resource collision.

When a PSFCH transmission resource is determined based on the slot in which the colliding resource reserved by the second communication device is located, if all colliding resources correspond to transmission of one PSFCH, in a case that there is much collision, overheads of PSFCH transmission also increase. Therefore, it may be considered to transmit the reselection indication on PSFCH resources corresponding to some specific colliding resources. For example, one resource is selected, to transmit the resource reselection indication, from one nearest PSFCH channel before a slot in which the first colliding resource is located. FIG. 5 is a third schematic diagram of resource collision indication according to an embodiment of this application.

Manner 3: The time domain resource location of the PSFCH resource is determined based on a third slot/sub-frame in which a resource with no collision reserved by the second communication device is located.

The determining the time domain resource location of the PSFCH resource based on a third slot/sub-frame in which a resource with no collision reserved by the second communication device is located includes:
determining a resource for which collision occurs at the earliest time in all colliding resources, and determining nearest T reserved resources before the resource for which collision occurs at the earliest time;
determining a third PSFCH resource based on slots/sub-frames in which the T reserved resources are located, where the third PFSCH resource is in the slots in which the T reserved resources are located, or the third PSFCH resource is in a slot/sub-frame before slots/sub-frames in which the T reserved resources are located, or the third PSFCH resource is in a slot/sub-frame after slots/sub-frames in which the T reserved resources are located; and
transmitting the first signaling on the third PSFCH resource; where
T is a positive integer.

For example, all colliding resources are determined, an earliest colliding resource is determined, and one or more nearest reserved resources before the colliding resource are found. A PSFCH resource is determined based on a slot in which the resources are located, and the PSFCH resource is in the slot. However, if no PSFCH is configured in the slot, it may be determined that the PSFCH resource is a slot before or after the slot.

### 2. Frequency Domain Resource of a PSFCH

A method for determining a frequency domain resource location of a PSFCH is described below.

In some embodiments, a frequency domain resource location of the PSFCH resource is determined in at least one of the following manners:

Manner 1: The frequency domain resource location of the PSFCH resource is determined based on SCI sent by the second communication device to indicate a reserved resource.

The determining the frequency domain resource location of the PSFCH resource based on SCI sent by the second communication device to indicate a reserved resource includes:
determining the frequency domain resource location of the PSFCH resource by using a start, end, or center frequency domain resource of the SCI as a reference point.

Manner 2: The frequency domain resource location of the PSFCH resource is determined based on a physical sidelink shared channel PSSCH associated with SCI sent by the second communication device to indicate a reserved resource.

The determining the frequency domain resource location of the PSFCH resource based on a PSSCH associated with SCI sent by the second communication device to indicate a reserved resource includes:
determining the frequency domain resource location of the PSFCH resource by using a start, end, or center frequency domain resource of the PSSCH as a reference point.

It may be understood that the first communication device determines the frequency domain resource location of the PSFCH by using a start frequency domain resource location, an end frequency domain resource location, or a center frequency domain resource location of the PSSCH associated with the SCI sent by the second communication device to indicate a reserved resource as a reference point.

Manner 3: The frequency domain resource location of the PSFCH resource is determined based on a location on which a colliding resource reserved by the second communication device is located.

In some implementations, the determining the frequency domain resource location of the PSFCH resource based on a location on which a colliding resource reserved by the second communication device is located includes:
determining the frequency domain resource location of the PSFCH resource by using a start, end, or center frequency domain resource of the colliding resource as a reference point.

Manner 4: The frequency domain resource location of the PSFCH resource is determined based on a location on which a resource with no collision reserved by the second communication device is located.

In some implementations, the determining the frequency domain resource location of the PSFCH resource based on a location on which a resource with no collision reserved by the second communication device is located includes at least one of the following:
determining the frequency domain resource location of the PSFCH resource by using a start, end, or center frequency domain resource of an earliest resource with no collision as a reference point;
determining the frequency domain resource location of the PSFCH resource by using a start, end, or center frequency domain resource of a resource with no collision before an earliest colliding resource as a reference point; or
determining the frequency domain resource location of the PSFCH resource by using a start, end, or center frequency domain resource of any resource with no collision as a reference point.

A quantity of frequency domain resources of a PSFCH is described below.

In some embodiments, the PSFCH resource occupies one or more PRBs in frequency domain.

In some embodiments, in a case that the PSFCH resource occupies one PRB in frequency domain, at least one of the following is met:
(1) Each code point of the first signaling corresponds to at least one information meaning, each information meaning corresponds to at least one M_CS value, each M_CS value corresponds to one cyclic prefix index value/cyclic prefix, for example, each M_CS value corresponds to one collision type, one collision state, or one collision location, first spacings between cyclic prefix index values/cyclic prefixes corresponding to each M_CS value are the same, and the first spacing is configured by a network side/higher layer.
(2) A default code point configured by a network side/higher layer is obtained as a reference code point for demodulating the first signaling, where the reference code point corresponds to one default state, and the reference code point corresponds to one configured M_CS value.
(3) An amount of first signaling or a quantity of PSFCHs transmitted by a same communication device supported by each PRB configured by a network side/higher layer is obtained.
(4) A quantity of cyclic prefix pairs supported by each PRB configured by a network side/higher layer is obtained.
(5) An amount of transmitted first signaling or a quantity of transmitted PSFCHs supported by each PRB configured by a network side/higher layer is obtained.
(6) A start index value of a cyclic prefix pair corresponding to each PRB configured by a network side/higher layer is obtained.
(7) A quantity of communication devices that are supported by each PRB configured by a network side/higher layer for sending the first signaling is received.

It should be noted that, when a same communication device sends first signaling on each PRB, each code point corresponds to one M_CS value, each M_CS value corresponds to one cyclic prefix index value/cyclic prefix, and cyclic prefix index values/cyclic prefixes corresponding to these M_CS values belong to a same cyclic prefix pair.

It should be further noted that a same communication device may simultaneously send a plurality of pieces of first signaling by using a PSFCH resource, and the first signaling carries different information.

It should be further noted that the information obtained from the network side/higher layer in the foregoing (1) to (7), that is, obtained by the upper layer/network through configuration, may be further pre-defined in a protocol, notified by a control node, notified by a terminal, or obtained through sharing, and the obtained signaling may be Radio Resource Control (RRC)/Downlink Control Information (DCI)/SCI/Media Access Control Control Element (MAC CE)/Sidelink Feedback Control Information (SFCI) or the like. After obtaining the information, the first communication device may select a resource on the PSFCH based on the information to transmit the first signaling.

A case that the reselection indication sent by each first communication device occupies one PRB is specifically described by using the following example:

It is assumed that the reselection indication carries information of only 1 bit, and corresponds to two code points and two states. It is assumed that one PRB can multiplex six PSFCHs, and in this case, six cyclic prefix pairs may be configured, and each cyclic prefix pair corresponds to PSFCH transmission of one user. Cyclic prefix pair index values corresponding to each PSFCH may be: 0/6, 1/7, 2/8, 3/9, 4/10, and 5/11. In this way, not only spacings between cyclic prefix index values corresponding to PSFCHs of a same user are the same, but also spacings between cyclic prefix index values corresponding to PSFCHs of different users are the same. In some implementations, a default state may be configured in each cyclic prefix pair. For example, the cyclic prefix pair index values 6/7/8/9/10/11 correspond to a default state, that is, a state with no PSFCH transmission may correspond to a state in which resource reselection does not need to be performed.

When the reselection indication carries information of only 2 bits, and corresponds to three code points and three states, it is assumed that one PRB can multiplex four PSFCHs, and in this case, four cyclic prefix sets may be configured, and each cyclic prefix set corresponds to PSFCH transmission of one user. Cyclic prefix set index values corresponding to each PSFCH may be: 0/4/8, 1/5/9, Feb. 6, 2010, and Mar. 7, 2011. In this way, not only spacings between cyclic prefix index values corresponding to PSFCHs of a same user are the same, but also spacings between cyclic prefix index values corresponding to PSFCHs of different users are the same. In some implementations, a default state may be configured in each cyclic prefix set. For example, the cyclic prefix pair index values Aug. 9, 2010/11 correspond to a default state, that is, a state with no PSFCH transmission may correspond to a state in which resource reselection does not need to be performed.

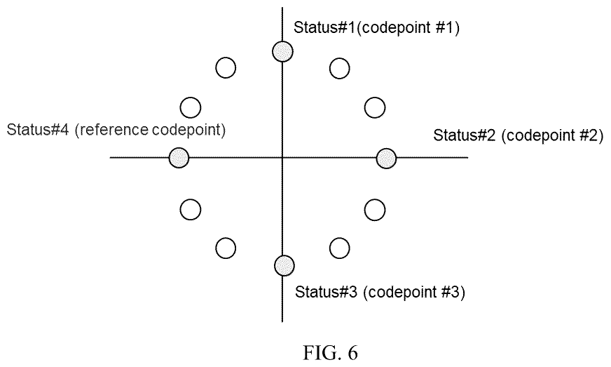

When the reselection indication carries information of only 2 bits, and corresponds to four code points and four states, it is assumed that one PRB can multiplex three PSFCHs, and in this case, three cyclic prefix sets may be configured, and each cyclic prefix set corresponds to PSFCH transmission of one user. Cyclic prefix pair index values corresponding to each PSFCH may be: 0/5/9, Jan. 6, 2010, and Feb. 7, 2011. In this way, not only spacings between cyclic prefix index values corresponding to PSFCHs of a same user are the same, but also spacings between cyclic prefix index values corresponding to PSFCHs of different users are the same. In some implementations, a default state may be configured in each cyclic prefix set. FIG. 6 is a schematic diagram of state configuration in a cyclic prefix set according to an embodiment of this application. For example, the cyclic prefix pair index value Sep. 10, 2011 corresponds to a default state, that is, a state with no PSFCH transmission may correspond to a state in which resource reselection does not need to be performed.

In some embodiments, in a case that the PSFCH resource occupies a plurality of PRBs in frequency domain, at least one of the following is met:
(1) Each code point of the first signaling corresponds to at least one information meaning, each information meaning corresponds to at least one M_CS value, and each M_CS value corresponds to one cyclic prefix index value/cyclic prefix, for example, each M_CS value corresponds to one collision type, one collision state, or one collision location.
(2) Each PRB is associated with at least one code point.
(3) The PRBs carry different information, and each PRB is associated with at least one type of indication information.
(4) An amount of first signaling or a quantity of PSFCHs transmitted by a same communication device supported by every W PRBs configured by a network side/higher layer is obtained.
(5) A quantity of cyclic prefix pairs supported by every W PRBs configured by a network side/higher layer is obtained.
(6) An amount of first signaling or a quantity of transmitted PSFCHs supported by every W PRBs configured by a network side/higher layer is obtained.
(7) A start index value of a cyclic prefix pair corresponding to every W PRBs configured by a network side/higher layer is obtained.
(8) A quantity of communication devices that are supported by every W PRBs configured by a network side/higher layer for sending the first signaling is received.
(9) On a same PRB, second spacings between cyclic prefix index values/cyclic prefixes corresponding to M_CS values are the same, where the second spacing is configured by a network side/higher layer.
(10) A default code point configured by a network side/higher layer is obtained as a reference code point for demodulating the first signaling, where the reference code point corresponds to one default state, and the reference code point corresponds to one configured M_CS value; where
W is a positive integer.

It should be noted that, when a same communication device sends first signaling on each PRB, each code point corresponds to one M_CS value, each M_CS value corresponds to one cyclic prefix index value/cyclic prefix, and cyclic prefix index values/cyclic prefixes corresponding to these M_CS values belong to a same cyclic prefix pair.

It should be further noted that a same communication device may simultaneously send a plurality of pieces of first signaling by using a PSFCH resource, and the first signaling carries different information.

It should be further noted that the information obtained from the network side/higher layer in the foregoing (1) to (10), that is, obtained by the upper layer/network through configuration, may be further pre-defined in a protocol, notified by a control node, notified by a terminal, or obtained through sharing, and the obtained signaling may be RRC/DCI/SCI/MAC CE/SFCI or the like.

In a case that a reselection indication sent by each first communication device occupies N PRBs, the reselection indication sent by each first communication device occupies N PRBs, and each PRB corresponds to one code point state. It is assumed that the reselection indication carries information of only 2 bits, and corresponds to three code points and three states, and in this case, three PRBs are occupied, and each PRB corresponds to one code point state. It is assumed that one PRB can multiplex six PSFCHs, and in this case, six cyclic prefix pairs may be configured, and each cyclic prefix pair corresponds to PSFCH transmission of one user. In this case, cyclic prefix pair index value corresponding to each PRB of each PSFCH may be 0/6, 1/7, 2/8, 3/9, 4/10, and 5/11. In some implementations, a default state may be configured in each cyclic prefix pair. For example, the cyclic prefix pair index values 6/7/8/9/10/11 correspond to a default state, that is, for a state corresponding to the PRB, indication information of the corresponding state is not received.

A multiplexing manner of the PSFCH resource is described below.

In some implementations, the multiplexing manner of the PSFCH resource includes at least one of the following:
a Frequency Division Multiplexing (FDM) manner;
a code division multiplexing manner; or
a Time Division Multiplexing (TDM) manner.

In some implementations, the frequency division multiplexing manner meets at least one of the following:
communication devices use different PRBs on the PFSCH when transmitting the first signaling; or
PRBs used by different communication devices to transmit the first signaling are consecutive or discrete on the PSFCH.

In some implementations, the code division multiplexing manner meets at least one of the following:
first signaling transmission or PSFCH transmission of a plurality of communication devices is multiplexed on a same PRB or a plurality of PRBs;
a quantity of cyclic prefix pairs supported by every V PRBs configured by a network side/higher layer is obtained;
an amount of first signaling or a quantity of PSFCHs from different communication devices supported by every V PRBs configured by a network side/higher layer is obtained;
a start index value of a cyclic prefix pair corresponding to code points of first signaling of different communication devices supported by every V PRBs configured by a network side/higher layer is obtained;
M_CS values corresponding to code points of first signaling of different communication devices supported by every V PRBs configured by a network side/higher layer is obtained, where each M_CS value corresponds to one cyclic prefix index value, and an M_CS value corresponding to a code point of first signaling of a same communication device comes from a same cyclic prefix pair;
a quantity of communication devices that are supported by every V PRBs configured by a network side/higher layer for sending the first signaling is received; or
on every V PRBs, third spacings between cyclic prefix index values/cyclic prefixes corresponding to M_CS values of different communication devices keep the same, where the third spacing is configured by a network side/higher layer; where
V is a positive integer.

It should be further noted that the information obtained from the network side/higher layer, that is, obtained by the upper layer/network through configuration, may be further pre-defined in a protocol, notified by a control node, notified by a terminal, or obtained through sharing, and the obtained signaling may be RRC/DCI/SCI/MAC CE/SFCI or the like.

In some implementations, the time division multiplexing manner meets at least one of the following:
first signaling of different communication devices is transmitted by using resources on different symbols;
first signaling of a same communication device is transmitted by using resources on a plurality of symbols, and information transmitted on different symbols is different, for example, a collision type is carried on a symbol #1, and location information of a colliding resource is carried on a symbol #2; or
first signaling of a same communication device is transmitted by using resources on a plurality of symbols, and information transmitted on different symbols is the same.

It should be noted that the foregoing multiplexing manners may be combined.

One or more pieces of information may be carried in first signaling sent by each first communication device. For example, the collision type information of the resource collision and the location information of the resource collision may be carried, or the information about whether to perform resource information, the collision type information of the resource collision, and the location information of the resource collision may be carried at the same time. There may be many combination forms. Resource occupation situations may be in the following manners:
Case 1: A plurality of pieces of indication information are multiplexed on a same PRB for transmission.
Case 2: A plurality of pieces of indication information are multiplexed on a plurality of PRBs in a form of FDM for transmission, and each PRB carries only one type of information.
Case 3: A plurality of pieces of indication information are multiplexed on a plurality of symbol resources in a form of TDM, and each symbol carries at least one type of information.
Case 4: A plurality of pieces of indication information are multiplexed on a plurality of PRBs of a plurality of symbols in a form of FDM and TDM.

The foregoing multiplexing manners may be pre-defined in a protocol, configured by a higher layer or a network side, or notified by a based station or a terminal.

In this embodiment of this application, different communication devices may be multiplexed in frequency domain or time domain, that is, different PRB resources are used in frequency domain for transmission, or different symbol resources are used in time domain for transmission, thereby avoiding interference between different communication devices. If there are many communication devices, the code division multiplexing manner may be considered, that is, reselection information transmission of a plurality of communication devices is multiplexed on a same resource, so that resource overheads can be effectively reduced, a configuration is flexible, more communication devices can send reselection signaling, and a system capacity is increased.

In some embodiments, a sequence length of the PSFCH resource, a sequence length for transmitting the PSFCH, or a sequence length for transmitting the first signaling is determined by using one of the following:
a quantity of code points or indication states corresponding to transmission of the first signaling;
a quantity of corresponding code points or a quantity of indication states when transmission of the first signaling by a plurality of communication devices is multiplexed on Y PRBs;
a quantity of code points corresponding to at least one PRB during transmission of the first signaling; or
a quantity of code points or a quantity of indication states on at least one PRB when transmission of the first signaling by a plurality of communication devices is multiplexed on Y PRBs; where
Y is a positive integer.

In some embodiments, a configuration manner of the PSFCH resource includes at least one of the following:
being configured in units of resource pools;
being configured in units of BWPs;
being configured in units of system bandwidth;
being independently configured for one or more transmission types; where
for example, for multicast communication, because the second communication device needs to demodulate a plurality of different PSFCH code points (for example, different code points are corresponding to different types of collision) sent by a plurality of first communication devices, a reference code point needs to be set to demodulate the plurality of PSFCH code points sent by the plurality of first communication devices; and
for another example, for unicast communication, because the second communication device needs to demodulate one PSFCH code point sent by one first communication device, a reference code point does not need to be set to demodulate the PSFCH code point;
being uniformly configured for a plurality of transmission types, and state interpretation of the PSFCH resource needs to be independently defined for one or some transmission types; where
for example, for unicast communication, a state 1 indicates a resource collision type 1, and a state 2 indicates a resource collision type 2; and for multicast communication, a state 1 indicates a resource collision, and a state 2 is a reference code point for demodulation of the PSFCH;
being independently configured for a resource collision type, where for example, one type of PSFCH resource is configured for collision caused by a half-duplex factor, and one type of PSFCH resource is configured for collision caused by partial/entire overlapping between resources reserved or selected by a communication device.

Advantages of independently configuring the PSFCH resource for transmission of the resource reselection indication for the resource collision type include:
Advantage 1: When available PSFCH state values/code points are insufficient to indicate all resource collision types, independently configuring a PSFCH resource for one/some resource collision types helps expand an indication capacity of the PSFCH.
Advantage 2: For multicast communication, if a plurality of PSSCH receive end UEs send a same PSFCH state (code point) to indicate a resource collision type, accumulated energy in the PSFCH state affects demodulation of another PSFCH state (code point). To enable a plurality of receive ends to separately indicate different resource collision types, different resource collision types may correspond to different PSFCH resources (for example, PSFCH resources located on different PRBs).

The resource collision type meets at least one of the following:
different PSSCH resources reserved by the second communication device respectively correspond to different resource collision types, as described above; or
different resource collision types detected by the first communication device or different collision determining manners of the first communication device (for example, a PSSCH collision conflict or Half Duplex (HD) collision on a UE-A side) correspond to different resource collision types.

Independent configuration for a HARQ feedback manner, where HARQ feedback manners include a manner in which both an ACK and a NACK are fed back, a manner in which only a NACK is fed back, and a blind retransmission manner in which neither an ACK or a NACK is fed back.

It may be understood that a configuration granularity of the PSFCH resource used for transmission of the resource reselection indication may be configured in units of resource pools, configured in units of BandWidth Parts (BWPs), configured in units of system bandwidth, independently configured for one or more transmission types, or uniformly configured for a plurality of transmission types, and state interpretation of the PSFCH resource needs to be independently defined for a specific or some transmission types, configured independently for a resource collision type, or configured independently for a HARQ feedback manner.

A definition manner of a reference code point for demodulation of the PSFCH:

One/more reference code points for demodulation of the PSFCH are set for each PSFCH resource, and the UE does not send a message at the code point.

In a system (such as each resource pool), one or more PSFCH demodulation reference states (such as reference code points) are configured. During PSFCH configuration, these reference states need to be ruled out first.

One/more reference PSFCH resources for demodulation of the PSFCH are set.

In some implementations, the reference PSFCH resource is explicitly configured, and configuration signaling indicates the PSFCH resource. Alternatively, a protocol specifies a PSFCH resource as a reference PSFCH resource.

In some implementations, when determining the PSFCH resource used for transmission of the PSFCH, the communication device first removes the reference PSFCH resource.

It should be noted that content carried in the resource reselection indication signaling (the first signaling), an expressed meaning, a configuration manner and a multiplexing manner of the PSFCH resource used to transmit the resource reselection indication, and a value of each variable may be configured by a network side/a base station, notified by a control node/a terminal, or pre-defined in a protocol, and a configuration or notification manner may be carried by using information such as RRC/SCI/DCI/MAC CE/SFCI.

In some implementations, in some resource pools, BWPs, or specific bandwidth, the PSFCH resource may not be configured to indicate sending of the resource reselection signaling (the first signaling).

In this embodiment of this application, content carried in the PSFCH resource for transmitting the reselection indication signaling, an expressed meaning, the configuration manner of the PSFCH resource, and the multiplexing manner of the PSFCH resource are provided, and content such as a resource location occupied when at least one first communication device sends the resource reselection indication signaling, a quantity, and a multiplexing manner can be determined, thereby effectively resolving a problem of using the PSFCH to transmit the resource reselection indication, improving transmission efficiency in a sidelink system, reducing signaling overheads, and improving system performance.

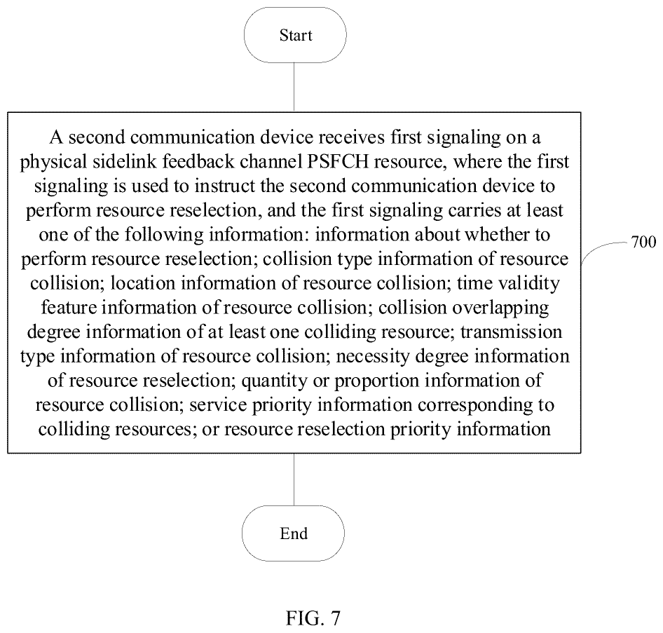

FIG. 7 is a second schematic flowchart of a physical sidelink feedback channel resource configuration method according to an embodiment of this application. As shown in FIG. 7, the physical sidelink feedback channel resource configuration method includes the following step:

Step 700: A second communication device receives first signaling on a PSFCH resource, where the first signaling is used to instruct the second communication device to perform resource reselection.

The first signaling carries at least one of the following information:
information about whether to perform resource reselection;
collision type information of resource collision;
location information of resource collision;
time validity feature information of resource collision;
collision overlapping degree information of at least one colliding resource;
transmission type information of resource collision;
necessity degree information of resource reselection;
quantity or proportion information of resource collision;
service priority information corresponding to colliding resources; or
resource reselection priority information.

In this embodiment, the second communication device is an execution body, and an action of a peer end in the foregoing embodiment is described. Therefore, for an understanding of same content in this embodiment as in the foregoing embodiment, reference may be made to the descriptions in the foregoing embodiment, and details are not described herein again.

It may be understood that the second communication device receives, on the PSFCH resource, the first signaling sent by the first communication device to instruct the second communication device to perform resource reselection.

The second communication device performs resource reselection based on information indicated by the first signaling.

In this embodiment of this application, resource reselection indication signaling is transmitted by using a PSFCH, so that a second communication device can be effectively helped in performing necessary resource reselection, and avoiding some unnecessary resource reselection, and therefore, resource reselection efficiency can be improved, transmission efficiency in a sidelink system can be improved, and system performance can be improved.

In some embodiments, the PSFCH resource occupies one or more symbols in time domain; where
in a case that the PSFCH resource occupies two symbols in time domain, resources on the symbols are used to transmit different information.

In some embodiments, the PSFCH resource occupies one or more PRBs in frequency domain.

In some embodiments, in a case that the PSFCH resource occupies one PRB in frequency domain, at least one of the following is met:
each code point of the first signaling corresponds to at least one information meaning, each information meaning corresponds to at least one M_CS value, each M_CS value corresponds to one cyclic prefix index value/cyclic prefix, first spacings between cyclic prefix index values/cyclic prefixes corresponding to each M_CS value are the same, and the first spacing is configured by a network side/higher layer;
a default code point configured by a network side/higher layer is obtained as a reference code point for demodulating the first signaling, where the reference code point corresponds to one default state, and the reference code point corresponds to one configured M_CS value;
an amount of first signaling or a quantity of PSFCHs transmitted by a same communication device supported by each PRB configured by a network side/higher layer is obtained;
a quantity of cyclic prefix pairs supported by each PRB configured by a network side/higher layer is obtained;
an amount of transmitted first signaling or a quantity of transmitted PSFCHs supported by each PRB configured by a network side/higher layer is obtained;
a start index value of a cyclic prefix pair corresponding to each PRB configured by a network side/higher layer is obtained; or
a quantity of communication devices that are supported by each PRB configured by a network side/higher layer for sending the first signaling is received.

In some embodiments, in a case that the PSFCH resource occupies a plurality of PRBs in frequency domain, at least one of the following is met:
each code point of the first signaling corresponds to at least one information meaning, each information meaning corresponds to at least one M_CS value, and each M_CS value corresponds to one cyclic prefix index value/cyclic prefix;
each PRB is associated with at least one code point;
the PRBs carry different information, and each PRB is associated with at least one type of indication information;
an amount of first signaling or a quantity of PSFCHs transmitted by a same communication device supported by every W PRBs configured by a network side/higher layer is obtained;
a quantity of cyclic prefix pairs supported by every W PRBs configured by a network side/higher layer is obtained;
an amount of first signaling or a quantity of transmitted PSFCHs supported by every W PRBs configured by a network side/higher layer is obtained;
a start index value of a cyclic prefix pair corresponding to every W PRBs configured by a network side/higher layer is obtained;
a quantity of communication devices that are supported by every W PRBs configured by a network side/higher layer for sending the first signaling is received;
on a same PRB, second spacings between cyclic prefix index values/cyclic prefixes corresponding to M_CS values are the same, where the second spacing is configured by a network side/higher layer; or
a default code point configured by a network side/higher layer is obtained as a reference code point for demodulating the first signaling, where the reference code point corresponds to one default state, and the reference code point corresponds to one configured M_CS value; where
W is a positive integer.

In some embodiments, a multiplexing manner of the PSFCH resource includes at least one of the following:
a frequency division multiplexing manner;
a code division multiplexing manner; or
a time division multiplexing manner.

In some embodiments, the frequency division multiplexing manner meets at least one of the following:
communication devices use different PRBs on the PFSCH when transmitting the first signaling; or
PRBs used by different communication devices to transmit the first signaling are consecutive or discrete on the PSFCH.

In some embodiments, the code division multiplexing manner meets at least one of the following:
first signaling transmission or PSFCH transmission of a plurality of communication devices is multiplexed on a same PRB or a plurality of PRBs;
a quantity of cyclic prefix pairs supported by every V PRBs configured by a network side/higher layer is obtained;
an amount of first signaling or a quantity of PSFCHs from different communication devices supported by every V PRBs configured by a network side/higher layer is obtained;
a start index value of a cyclic prefix pair corresponding to code points of first signaling of different communication devices supported by every V PRBs configured by a network side/higher layer is obtained;
M_CS values corresponding to code points of first signaling of different communication devices supported by every V PRBs configured by a network side/higher layer is obtained, where each M_CS value corresponds to one cyclic prefix index value, and an M_CS value corresponding to a code point of first signaling of a same communication device comes from a same cyclic prefix pair;
a quantity of communication devices that are supported by every V PRBs configured by a network side/higher layer for sending the first signaling is received; or
on every V PRBs, third spacings between cyclic prefix index values/cyclic prefixes corresponding to M_CS values of different communication devices keep the same, where the third spacing is configured by a network side/higher layer; where
V is a positive integer.

In some embodiments, the time division multiplexing manner meets at least one of the following:
first signaling of different communication devices is transmitted by using resources on different symbols;
first signaling of a same communication device is transmitted by using resources on a plurality of symbols, and information transmitted on different symbols is different; or
first signaling of a same communication device is transmitted by using resources on a plurality of symbols, and information transmitted on different symbols is the same.

In some embodiments, a sequence length of the PSFCH resource, a sequence length for transmitting the PSFCH, or a sequence length for transmitting the first signaling is determined by using one of the following:
a quantity of code points or indication states corresponding to transmission of the first signaling;
a quantity of corresponding code points or a quantity of indication states when transmission of the first signaling by a plurality of communication devices is multiplexed on Y PRBs;
a quantity of code points corresponding to at least one PRB during transmission of the first signaling; or
a quantity of code points or a quantity of indication states on at least one PRB when transmission of the first signaling by a plurality of communication devices is multiplexed on Y PRBs; where
Y is a positive integer.

In some embodiments, a configuration manner of the PSFCH resource includes at least one of the following:
being configured in units of resource pools;
being configured in units of BWPs;
being configured in units of system bandwidth;
being independently configured for one or more transmission types;
being uniformly configured for a plurality of transmission types, and state interpretation of the PSFCH resource needs to be independently defined for one or some transmission types;
being independently configured for a resource collision type; or
being independently configured for a HARQ feedback manner.

In this embodiment of this application, content carried in the reselection indication signaling, an expressed meaning, and the configuration manner and the multiplexing manner of the PSFCH resource are provided, and content such as a resource location occupied when at least one first communication device sends the resource reselection indication signaling, a quantity, and a multiplexing manner can be determined, thereby effectively resolving a problem of using the PSFCH to transmit the resource reselection indication, improving transmission efficiency in a sidelink system, reducing signaling overheads, and improving system performance.

It should be noted that in the physical sidelink feedback channel resource configuration method provided in this embodiment of this application, an execution body may be a physical sidelink feedback channel resource configuration apparatus, or a control module that is in the physical sidelink feedback channel resource configuration apparatus and that is configured to perform the physical sidelink feedback channel resource configuration method. In this embodiment of this application, an example in which the physical sidelink feedback channel resource configuration apparatus performs the physical sidelink feedback channel resource configuration method is used to describe the physical sidelink feedback channel resource configuration apparatus provided in this embodiment of this application.

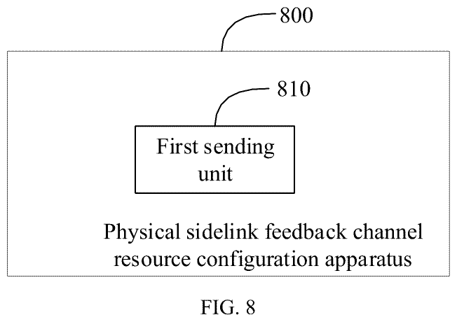

FIG. 8 is a first schematic diagram of a structure of a physical sidelink feedback channel resource configuration apparatus according to an embodiment of this application. As shown in FIG. 8, the physical sidelink feedback channel resource configuration apparatus 800 includes:
a first sending unit 810, used by a first communication device to send first signaling to a second communication device by using a PSFCH resource according to a first rule, where the first signaling is used to instruct the second communication device to perform resource reselection.

The first signaling carries at least one of the following information:
information about whether to perform resource reselection;
collision type information of resource collision;
location information of resource collision;
time validity feature information of resource collision;
collision overlapping degree information of at least one colliding resource;
transmission type information of resource collision;
necessity degree information of resource reselection;
quantity or proportion information of resource collision;
service priority information corresponding to colliding resources; or
resource reselection priority information.

In this embodiment of this application, resource reselection indication signaling is transmitted by using a PSFCH, so that a second communication device can be effectively helped in performing necessary resource reselection, and avoiding some unnecessary resource reselection, and therefore, resource reselection efficiency can be improved, transmission efficiency in a sidelink system can be improved, and system performance can be improved.

In some implementations, the first rule includes at least one of the following:
the first communication device detects that a resource selected or reserved by the second communication device collides with the resource selected or reserved by the first communication device;
the first communication device detects that a resource selected or reserved by a third communication device collides with a resource selected or reserved by the second communication device;
the first communication device detects that an uplink transmission resource of the first communication device collides with a resource selected or reserved by the second communication device; or
the first communication device detects that an uplink transmission resource of a third communication device collides with a resource selected or reserved by the second communication device; where
the third communication device is another communication device except the first communication device.

In some implementations, the resource collision includes at least one of the following:
time domain resources partially or entirely overlap; or
frequency domain resources partially or entirely overlap.

In some implementations, the collision type information of the resource collision includes at least one of the following:
collision caused by entire or partial overlapping between the resource selected or reserved by the second communication device and the resource selected or reserved by the third communication device;
collision caused by entire or partial overlapping between a PSFCH resource associated with the resource selected or reserved by the second communication device and a PSFCH resource associated with the resource selected or reserved by the third communication device;
collision caused by entire or partial overlapping between a PSFCH resource associated with the resource selected or reserved by the second communication device and the resource selected or reserved by the third communication device;
collision caused by entire or partial overlapping between the resource selected or reserved by the second communication device and a PSFCH resource associated with the resource selected or reserved by the third communication device;
collision caused by entire or partial overlapping between the resource selected or reserved by the second communication device and the uplink transmission resource of the third communication device;
collision caused by entire or partial overlapping between a PSFCH resource associated with the resource selected or reserved by the second communication device and the uplink transmission resource of the third communication device;
collision caused by entire or partial overlapping between the resource selected or reserved by the second communication device and a resource location selected or reserved by the first communication device to perform sidelink SL transmission;
collision caused by entire or partial overlapping between the resource selected or reserved by the second communication device and a resource location at which the first communication device performs uplink UL transmission;
collision caused by entire or partial overlapping between a PSFCH resource associated with the resource selected or reserved by the second communication device and the resource selected or reserved by the first communication device;
collision caused by entire or partial overlapping between a PSFCH resource associated with the resource selected or reserved by the second communication device and a PSFCH resource associated with the resource selected or reserved by the first communication device;
collision caused by entire or partial overlapping between a PSFCH resource associated with the resource selected or reserved by the second communication device and an uplink UL transmission resource of the first communication device; or
collision caused by entire or partial overlapping between the resource selected or reserved by the second communication device and a PSFCH resource associated with the resource selected or reserved by the first communication device.

In some implementations, the location information of the resource collision includes at least one of the following:
some/all resources in the first N/K periods in the periodically reserved resources;
an M^{th} resource in the first N/K periods in the periodically reserved resources;
first/last M resources in the first N/K periods in the periodically reserved resources;
an M^{th} resource in aperiodically reserved resources;
all or some resources in aperiodically reserved resources; or
first/last M resources in aperiodically reserved resources; where
N, K, and M are positive integers.

In some implementations, the time validity feature information of the resource collision includes at least one of the following:
there is resource collision in a P^{th} period in periodically reserved resources;
there is resource collision in the first P periods in periodically reserved resources;
there is resource collision in the last P periods in periodically reserved resources;
there is a conflict in first preset duration after a current moment in periodically reserved resources;
there is a conflict in first preset duration after a current moment in aperiodically reserved resources;
there is resource collision in the first Q reserved resources in aperiodically reserved resources;
there is resource collision in the last Q reserved resources in aperiodically reserved resources; or
there is resource collision in a Q^{th} reserved resource in aperiodically reserved resources; where
both P and Q are positive integers.

In some implementations, the collision overlapping degree information of at least one colliding resource includes at least one of the following:
partial overlapping or entire overlapping;
a quantity of overlapping subchannels, a quantity of slots, a quantity of physical resource blocks, or a quantity of symbols;
a proportion of overlapping resources to a total quantity of resources reserved by the second communication device; or
a proportion of overlapping resources to current colliding resources reserved by the second communication device.

In some implementations, the transmission type information of the resource collision includes at least one of the following:
colliding resources are used for unicast transmission, multicast transmission, or broadcast transmission;
colliding resources are used to send data to a specific communication device or a specific group; or
colliding resources are used to send data to a control node.

In some implementations, the necessity degree information of the resource collision includes at least one of the following:
resource reselection that is necessary, that is suggested to be performed, that is suggested not to be performed, or that is unnecessary; or
a weight coefficient, where the weight coefficient is used to indicate a necessity degree of resource reselection.

In some implementations, the quantity or proportion information of the resource collision includes at least one of the following:
a quantity of colliding resources;
a proportion of colliding resources to a total quantity of resources reserved by the second communication device or a total quantity of resources reserved by the second communication device in at least one period;
a quantity of colliding resources in second preset duration; or
a proportion of colliding resources in second preset duration to a total quantity of resources reserved by the second communication device in the second preset duration or a total quantity of resources reserved by the second communication device in at least one period in the second preset duration; where
the quantity of colliding resources includes:
a quantity of colliding slots, subchannels, symbols, or physical resource blocks; and
the total quantity of reserved resources includes:
a total quantity of reserved slots, subchannels, symbols, or physical resource blocks.

In some implementations, the service priority information corresponding to colliding resources includes at least one of the following:
service priority information of a conflicting source device corresponding to the colliding resources;
a difference between a service priority of the second communication device and a service priority of a conflicting source device on the colliding resources or an absolute value of the difference; or
a relationship between a service priority of the second communication device and a service priority of a conflicting source device on the colliding resources; where
the conflicting source device is the first communication device or the third communication device.

In some implementations, the PSFCH resource occupies one or two symbols in time domain.

In a case that the PSFCH resource occupies two symbols in time domain, resources on the symbols are used to transmit different information.

In some implementations, the time domain resource location of the PSFCH resource is determined in at least one of the following manners:
determining the time domain resource location of the PSFCH resource based on a first slot/sub-frame in which sidelink control information SCI sent by the second communication device to indicate a reserved resource is located;
determining the time domain resource location of the PSFCH resource based on a second slot/sub-frame in which a colliding resource reserved by the second communication device is located; or
determining the time domain resource location of the PSFCH resource based on a third slot/sub-frame in which a resource with no collision reserved by the second communication device is located.

In some implementations, the determining the time domain resource location of the PSFCH resource based on a first slot/sub-frame in which SCI sent by the second communication device to indicate a reserved resource is located includes at least one of the following:
in a case that there is a first PSFCH resource in the first slot/sub-frame, determining to transmit the first signaling by using the first PSFCH resource;
in a case that there is no PSFCH resource in the first slot/sub-frame, determining to transmit the first signaling by using a PSFCH resource that is nearest to the first slot/sub-frame;
transmitting the first signaling by using a PSFCH resource in an L^{th} slot/sub-frame after the first slot;
transmitting the first signaling by using a PSFCH resource that is nearest to an L^{th} slot/sub-frame after the first slot, where the nearest PSFCH resource is before or after the L^{th} slot/sub-frame after the first slot; or
transmitting the first signaling by using at least one PSFCH resource in third preset duration after the first slot; where
L is a positive integer.

In some implementations, the determining the time domain resource location of the PSFCH resource based on a second slot/sub-frame in which a colliding resource reserved by the second communication device is located includes at least one of the following:
transmitting the first signaling on a PSFCH resource in U slots/sub-frames before a second slot in which at least one colliding resource is located or in fourth preset duration;
transmitting the first signaling on a PSFCH resource that is nearest to a second slot in which at least one colliding resource is located;
transmitting the first signaling on a PSFCH resource that is before or after H slots/sub-frames before a second slot in which at least one colliding resource is located; or
selecting X PSFCH resources from R slots/sub-frames in R slots/sub-frames before a second slot in which at least one colliding resource is located or in fifth preset duration as a second PSFCH resource, and transmitting the first signaling on the second PSFCH resource; where
U, H, R, and X are positive integers.

In some implementations, the determining the time domain resource location of the PSFCH resource based on a third slot/sub-frame in which a resource with no collision reserved by the second communication device is located includes:
determining a resource for which collision occurs at the earliest time in all colliding resources, and determining nearest T reserved resources before the resource for which collision occurs at the earliest time;
determining a third PSFCH resource based on slots/sub-frames in which the T reserved resources are located, where the third PFSCH resource is in the slots in which the T reserved resources are located, or the third PSFCH resource is in a slot/sub-frame before slots/sub-frames in which the T reserved resources are located, or the third PSFCH resource is in a slot/sub-frame after slots/sub-frames in which the T reserved resources are located; and
transmitting the first signaling on the third PSFCH resource; where
T is a positive integer.

In some implementations, a frequency domain resource location of the PSFCH resource is determined in at least one of the following manners:
determining the frequency domain resource location of the PSFCH resource based on SCI sent by the second communication device to indicate a reserved resource;
determining the frequency domain resource location of the PSFCH resource based on a physical sidelink shared channel PSSCH associated with SCI sent by the second communication device to indicate a reserved resource;
determining the frequency domain resource location of the PSFCH resource based on a location on which a colliding resource reserved by the second communication device is located; or
determining the frequency domain resource location of the PSFCH resource based on a location on which a resource with no collision reserved by the second communication device is located.

In some implementations, the determining the frequency domain resource location of the PSFCH resource based on SCI sent by the second communication device to indicate a reserved resource includes:
determining the frequency domain resource location of the PSFCH resource by using a start, end, or center frequency domain resource of the SCI as a reference point.

In some implementations, the determining the frequency domain resource location of the PSFCH resource based on a PSSCH associated with SCI sent by the second communication device to indicate a reserved resource includes:
determining the frequency domain resource location of the PSFCH resource by using a start, end, or center frequency domain resource of the PSSCH as a reference point.

In some implementations, the determining the frequency domain resource location of the PSFCH resource based on a location on which a colliding resource reserved by the second communication device is located includes:
determining the frequency domain resource location of the PSFCH resource by using a start, end, or center frequency domain resource of the colliding resource as a reference point.

In some implementations, the determining the frequency domain resource location of the PSFCH resource based on a location on which a resource with no collision reserved by the second communication device is located includes at least one of the following:
determining the frequency domain resource location of the PSFCH resource by using a start, end, or center frequency domain resource of an earliest resource with no collision as a reference point;
determining the frequency domain resource location of the PSFCH resource by using a start, end, or center frequency domain resource of a resource with no collision before an earliest colliding resource as a reference point; or
determining the frequency domain resource location of the PSFCH resource by using a start, end, or center frequency domain resource of any resource with no collision as a reference point.

In some implementations, the PSFCH resource occupies one or more PRBs in frequency domain.

In some implementations, in a case that the PSFCH resource occupies one PRB in frequency domain, at least one of the following is met:
each code point of the first signaling corresponds to at least one information meaning, each information meaning corresponds to at least one M_CS value, each M_CS value corresponds to one cyclic prefix index value/cyclic prefix, first spacings between cyclic prefix index values/cyclic prefixes corresponding to each M_CS value are the same, and the first spacing is configured by a network side/higher layer;
a default code point configured by a network side/higher layer is obtained as a reference code point for demodulating the first signaling, where the reference code point corresponds to one default state, and the reference code point corresponds to one configured M_CS value;
an amount of first signaling or a quantity of PSFCHs transmitted by a same communication device supported by each PRB configured by a network side/higher layer is obtained;
a quantity of cyclic prefix pairs supported by each PRB configured by a network side/higher layer is obtained;
an amount of transmitted first signaling or a quantity of transmitted PSFCHs supported by each PRB configured by a network side/higher layer is obtained;
a start index value of a cyclic prefix pair corresponding to each PRB configured by a network side/higher layer is obtained; or
a quantity of communication devices that are supported by each PRB configured by a network side/higher layer for sending the first signaling is received.

In some implementations, in a case that the PSFCH resource occupies a plurality of PRBs in frequency domain, at least one of the following is met:
each code point of the first signaling corresponds to at least one information meaning, each information meaning corresponds to at least one M_CS value, and each M_CS value corresponds to one cyclic prefix index value/cyclic prefix;
each PRB is associated with at least one code point;
the PRBs carry different information, and each PRB is associated with at least one type of indication information;
an amount of first signaling or a quantity of PSFCHs transmitted by a same communication device supported by every W PRBs configured by a network side/higher layer is obtained;
a quantity of cyclic prefix pairs supported by every W PRBs configured by a network side/higher layer is obtained;
an amount of first signaling or a quantity of transmitted PSFCHs supported by every W PRBs configured by a network side/higher layer is obtained;
a start index value of a cyclic prefix pair corresponding to every W PRBs configured by a network side/higher layer is obtained;
a quantity of communication devices that are supported by every W PRBs configured by a network side/higher layer for sending the first signaling is received;
on a same PRB, second spacings between cyclic prefix index values/cyclic prefixes corresponding to M_CS values are the same, where the second spacing is configured by a network side/higher layer; or
a default code point configured by a network side/higher layer is obtained as a reference code point for demodulating the first signaling, where the reference code point corresponds to one default state, and the reference code point corresponds to one configured M_CS value; where
W is a positive integer.

In some implementations, the multiplexing manner of the PSFCH resource includes at least one of the following:
a frequency division multiplexing manner;
a code division multiplexing manner; or
a time division multiplexing manner.

In some implementations, the frequency division multiplexing manner meets at least one of the following:
communication devices use different PRBs on the PFSCH when transmitting the first signaling; or
PRBs used by different communication devices to transmit the first signaling are consecutive or discrete on the PSFCH.

In some implementations, the code division multiplexing manner meets at least one of the following:
first signaling transmission or PSFCH transmission of a plurality of communication devices is multiplexed on a same PRB or a plurality of PRBs;
a quantity of cyclic prefix pairs supported by every V PRBs configured by a network side/higher layer is obtained;
an amount of first signaling or a quantity of PSFCHs from different communication devices supported by every V PRBs configured by a network side/higher layer is obtained;
a start index value of a cyclic prefix pair corresponding to code points of first signaling of different communication devices supported by every V PRBs configured by a network side/higher layer is obtained;
M_CS values corresponding to code points of first signaling of different communication devices supported by every V PRBs configured by a network side/higher layer is obtained, where each M_CS value corresponds to one cyclic prefix index value, and an M_CS value corresponding to a code point of first signaling of a same communication device comes from a same cyclic prefix pair;
a quantity of communication devices that are supported by every V PRBs configured by a network side/higher layer for sending the first signaling is received; or
on every V PRBs, third spacings between cyclic prefix index values/cyclic prefixes corresponding to M_CS values of different communication devices keep the same, where the third spacing is configured by a network side/higher layer; where
V is a positive integer.

In some implementations, the time division multiplexing manner meets at least one of the following:
first signaling of different communication devices is transmitted by using resources on different symbols;
first signaling of a same communication device is transmitted by using resources on a plurality of symbols, and information transmitted on different symbols is different; or
first signaling of a same communication device is transmitted by using resources on a plurality of symbols, and information transmitted on different symbols is the same.

In some implementations, a sequence length of the PSFCH resource, a sequence length for transmitting the PSFCH, or a sequence length for transmitting the first signaling is determined by using one of the following:
a quantity of code points or indication states corresponding to transmission of the first signaling;
a quantity of corresponding code points or a quantity of indication states when transmission of the first signaling by a plurality of communication devices is multiplexed on Y PRBs;
a quantity of code points corresponding to at least one PRB during transmission of the first signaling; or
a quantity of code points or a quantity of indication states on at least one PRB when transmission of the first signaling by a plurality of communication devices is multiplexed on Y PRBs; where
Y is a positive integer.

In some implementations, the configuration manner of the PSFCH resource includes at least one of the following:
being configured in units of resource pools;
being configured in units of BWPs;
being configured in units of system bandwidth;
being independently configured for one or more transmission types;
being uniformly configured for a plurality of transmission types, and state interpretation of the PSFCH resource needs to be independently defined for one or some transmission types;
being independently configured for a resource collision type; or
being independently configured for a HARQ feedback manner.

The physical sidelink feedback channel resource configuration apparatus in this embodiment of this application may be an apparatus or an apparatus or an electronic device having an operating system, or may be a component, an integrated circuit, or a chip in a terminal or a network side device.

The physical sidelink feedback channel resource configuration apparatus provided in this embodiment of this application can implement the processes implemented in the method embodiments in FIG. 2 to FIG. 6, and a same technical effect can be achieved. To avoid repetition, details are not described herein again.

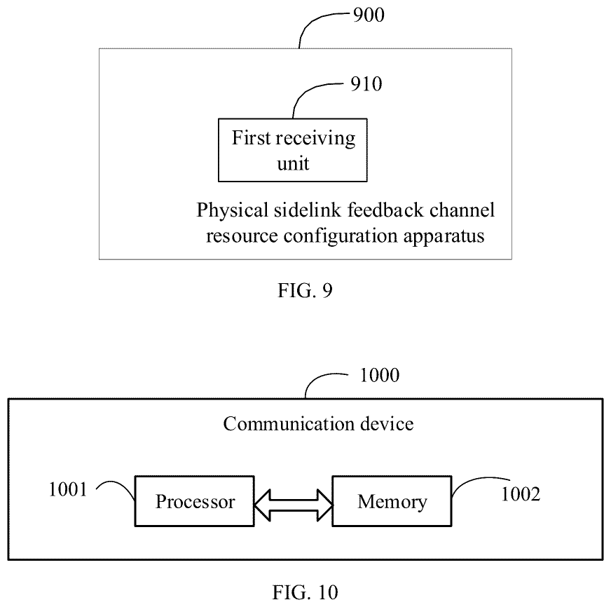

FIG. 9 is a second schematic diagram of a structure of a physical sidelink feedback channel resource configuration apparatus according to an embodiment of this application. As shown in FIG. 9, the physical sidelink feedback channel resource configuration apparatus 900 includes:
a first receiving unit 910, configured to receive first signaling on a PSFCH resource, where the first signaling is used to instruct the second communication device to perform resource reselection.

The first signaling carries at least one of the following information:
information about whether to perform resource reselection;
collision type information of resource collision;
location information of resource collision;
time validity feature information of resource collision;
collision overlapping degree information of at least one colliding resource;
transmission type information of resource collision;
necessity degree information of resource reselection;
quantity or proportion information of resource collision;
service priority information corresponding to colliding resources; or
resource reselection priority information.

In some implementations, the PSFCH resource occupies one or two symbols in time domain; where
in a case that the PSFCH resource occupies two symbols in time domain, resources on the symbols are used to transmit different information.

In some implementations, the PSFCH resource occupies one or more PRBs in frequency domain.

In some implementations, in a case that the PSFCH resource occupies one PRB in frequency domain, at least one of the following is met:
each code point of the first signaling corresponds to at least one information meaning, each information meaning corresponds to at least one M_CS value, each M_CS value corresponds to one cyclic prefix index value/cyclic prefix, first spacings between cyclic prefix index values/cyclic prefixes corresponding to each M_CS value are the same, and the first spacing is configured by a network side/higher layer;
a default code point configured by a network side/higher layer is obtained as a reference code point for demodulating the first signaling, where the reference code point corresponds to one default state, and the reference code point corresponds to one configured M_CS value;
an amount of first signaling or a quantity of PSFCHs transmitted by a same communication device supported by each PRB configured by a network side/higher layer is obtained;
a quantity of cyclic prefix pairs supported by each PRB configured by a network side/higher layer is obtained;
an amount of transmitted first signaling or a quantity of transmitted PSFCHs supported by each PRB configured by a network side/higher layer is obtained;
a start index value of a cyclic prefix pair corresponding to each PRB configured by a network side/higher layer is obtained; or
a quantity of communication devices that are supported by each PRB configured by a network side/higher layer for sending the first signaling is received.

In some implementations, in a case that the PSFCH resource occupies a plurality of PRBs in frequency domain, at least one of the following is met:
each code point of the first signaling corresponds to at least one information meaning, each information meaning corresponds to at least one M_CS value, and each M_CS value corresponds to one cyclic prefix index value/cyclic prefix;
each PRB is associated with at least one code point;
the PRBs carry different information, and each PRB is associated with at least one type of indication information;
an amount of first signaling or a quantity of PSFCHs transmitted by a same communication device supported by every W PRBs configured by a network side/higher layer is obtained;
a quantity of cyclic prefix pairs supported by every W PRBs configured by a network side/higher layer is obtained;
an amount of first signaling or a quantity of transmitted PSFCHs supported by every W PRBs configured by a network side/higher layer is obtained;
a start index value of a cyclic prefix pair corresponding to every W PRBs configured by a network side/higher layer is obtained;
a quantity of communication devices that are supported by every W PRBs configured by a network side/higher layer for sending the first signaling is received;
on a same PRB, second spacings between cyclic prefix index values/cyclic prefixes corresponding to M_CS values are the same, where the second spacing is configured by a network side/higher layer; or
a default code point configured by a network side/higher layer is obtained as a reference code point for demodulating the first signaling, where the reference code point corresponds to one default state, and the reference code point corresponds to one configured M_CS value; where
W is a positive integer.

In some implementations, the multiplexing manner of the PSFCH resource includes at least one of the following:
a frequency division multiplexing manner;
a code division multiplexing manner; or
a time division multiplexing manner.

In some implementations, the frequency division multiplexing manner meets at least one of the following:
communication devices use different PRBs on the PFSCH when transmitting the first signaling; or
PRBs used by different communication devices to transmit the first signaling are consecutive or discrete on the PSFCH.

In some implementations, the code division multiplexing manner meets at least one of the following:
first signaling transmission or PSFCH transmission of a plurality of communication devices is multiplexed on a same PRB or a plurality of PRBs;
a quantity of cyclic prefix pairs supported by every V PRBs configured by a network side/higher layer is obtained;
an amount of first signaling or a quantity of PSFCHs from different communication devices supported by every V PRBs configured by a network side/higher layer is obtained;
a start index value of a cyclic prefix pair corresponding to code points of first signaling of different communication devices supported by every V PRBs configured by a network side/higher layer is obtained;
M_CS values corresponding to code points of first signaling of different communication devices supported by every V PRBs configured by a network side/higher layer is obtained, where each M_CS value corresponds to one cyclic prefix index value, and an M_CS value corresponding to a code point of first signaling of a same communication device comes from a same cyclic prefix pair;
a quantity of communication devices that are supported by every V PRBs configured by a network side/higher layer for sending the first signaling is received; or
on every V PRBs, third spacings between cyclic prefix index values/cyclic prefixes corresponding to M_CS values of different communication devices keep the same, where the third spacing is configured by a network side/higher layer; where
V is a positive integer.

In some implementations, the time division multiplexing manner meets at least one of the following:
first signaling of different communication devices is transmitted by using resources on different symbols;
first signaling of a same communication device is transmitted by using resources on a plurality of symbols, and information transmitted on different symbols is different; or
first signaling of a same communication device is transmitted by using resources on a plurality of symbols, and information transmitted on different symbols is the same.

In some implementations, a sequence length of the PSFCH resource, a sequence length for transmitting the PSFCH, or a sequence length for transmitting the first signaling is determined by using one of the following:
a quantity of code points or indication states corresponding to transmission of the first signaling;
a quantity of corresponding code points or a quantity of indication states when transmission of the first signaling by a plurality of communication devices is multiplexed on Y PRBs;
a quantity of code points corresponding to at least one PRB during transmission of the first signaling; or
a quantity of code points or a quantity of indication states on at least one PRB when transmission of the first signaling by a plurality of communication devices is multiplexed on Y PRBs; where
Y is a positive integer.

In some implementations, the configuration manner of the PSFCH resource includes at least one of the following:
being configured in units of resource pools;
being configured in units of BWPs;
being configured in units of system bandwidth;
being independently configured for one or more transmission types;
being uniformly configured for a plurality of transmission types, and state interpretation of the PSFCH resource needs to be independently defined for one or some transmission types;
being independently configured for a resource collision type; or
being independently configured for a HARQ feedback manner.

The physical sidelink feedback channel resource configuration apparatus in this embodiment of this application may be an apparatus or an apparatus or an electronic device having an operating system, or may be a component, an integrated circuit, or a chip in a terminal or a network side device.

The physical sidelink feedback channel resource configuration apparatus provided in this embodiment of this application can implement the processes implemented in the method embodiments in FIG. 7, and a same technical effect can be achieved. To avoid repetition, details are not described herein again.

In some implementations, as shown in FIG. 10, an embodiment of this application further provides a communication device 1000, including a processor 1001, a memory 1002, and a program or an instruction that is stored in the memory 1002 and that can run on the processor 1001. For example, when the communication device 1000 is a terminal, the program or the instruction is executed by the processor 1001 to implement the processes of the embodiment of the foregoing physical sidelink feedback channel resource configuration method, and a same technical effect can be achieved. When the communication device 1000 is a network side device, the program or the instruction is executed by the processor 1001 to implement the processes of the embodiment of the foregoing physical sidelink feedback channel resource configuration method, and a same technical effect can be achieved. To avoid repetition, details are not described herein again.

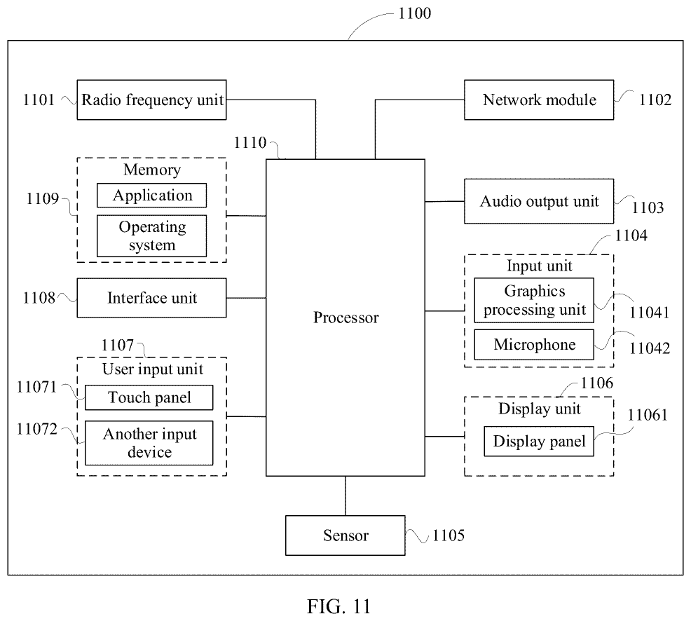

An embodiment of this application further provides a first communication device, including a processor and a communication interface. The processor is configured to send first signaling to a second communication device by using a PSFCH resource according to a first rule, where the first signaling is used to instruct the second communication device to perform resource reselection, and the first signaling carries at least one of the following information: information about whether to perform resource reselection; collision type information of resource collision; location information of resource collision; time validity feature information of resource collision; collision overlapping degree information of at least one colliding resource; transmission type information of resource collision; necessity degree information of resource reselection; quantity or proportion information of resource collision; service priority information corresponding to colliding resources; or resource reselection priority information. This embodiment of the first communication device is corresponding to the foregoing method embodiment of the first communication device side. Each implementation process and implementation manner of the foregoing method embodiment may be applicable to this embodiment of the first communication device, and a same technical effect can be achieved. FIG. 11 is a schematic diagram of a hardware structure of a first communication device for implementing embodiments of this application.

A terminal 1100 includes but is not limited to at least a part of components such as a radio frequency unit 1101, a network module 1102, an audio output unit 1103, an input unit 1104, a sensor 1105, a display unit 1106, a user input unit 1107, an interface unit 1108, a memory 1109, and a processor 1110.

It may be understood by a person skilled in the art that the first communication device 1100 may further include a power supply (such as a battery) that supplies power to each component. The power supply may be logically connected to the processor 1110 by using a power management system, to implement functions such as charging, discharging, and power consumption management by using the power management system. The terminal structure shown in FIG. 11 constitutes no limitation on the terminal, and the terminal may include more or fewer components than those shown in the figure, or combine some components, or have different component arrangements. Details are not described herein.

It should be understood that in this embodiment of this application, the input unit 1104 may include a Graphics Processing Unit (GPU) 11041 and a microphone 11042. The graphics processing unit 11041 processes image data of a static picture or a video obtained by an image capture apparatus (for example, a camera) in a video capture mode or an image capture mode. The display unit 1106 may include a display panel 11061. In some implementations, the display panel 11061 may be configured in a form such as a liquid crystal display or an organic light-emitting diode. The user input unit 1107 includes a touch panel 11071 and another input device 11072. The touch panel 11071 is also referred to as a touchscreen. The touch panel 11071 may include two parts: a touch detection apparatus and a touch controller. The another input device 11072 may include but is not limited to a physical keyboard, a functional button (such as a volume control button or a power on/off button), a trackball, a mouse, and a joystick. Details are not described herein.

In this embodiment of this application, the radio frequency unit 1101 receives downlink data from a network side device and then sends the downlink data to the processor 1110 for processing; and sends uplink data to the network side device. Usually, the radio frequency unit 1101 includes but is not limited to an antenna, at least one amplifier, a transceiver, a coupler, a low noise amplifier, a duplexer, and the like.

The memory 1109 may be configured to store a software program or an instruction and various data. The memory 1109 may mainly include a program or instruction storage area and a data storage area. The program or instruction storage area may store an operating system, an application or an instruction required by at least one function (for example, a sound playing function or an image playing function), and the like. In addition, the memory 1109 may include a high-speed random access memory, and may further include a non-volatile memory. The non-volatile memory may be a Read-Only Memory (ROM), a Programmable ROM (PROM), an Erasable PROM (EPROM), an Electrically EPROM (EEPROM), or a flash memory, for example, at least one disk storage device, a flash memory device, or another non-volatile solid-state storage device.

The processor 1110 may include one or more processing units. In some implementations, an application processor and a modem processor may be integrated into the processor 1110. The application processor mainly processes an operating system, a user interface, an application, an instruction, or the like. The modem processor mainly processes wireless communication, for example, a baseband processor. It may be understood that, the modem processor may alternatively not be integrated into the processor 1110.

The processor 1110 is configured to send first signaling to a second communication device by using a PSFCH resource according to a first rule, where the first signaling is used to instruct the second communication device to perform resource reselection, and the first signaling carries at least one of the following information: information about whether to perform resource reselection; collision type information of resource collision; location information of resource collision; time validity feature information of resource collision; collision overlapping degree information of at least one colliding resource; transmission type information of resource collision; necessity degree information of resource reselection; quantity or proportion information of resource collision; service priority information corresponding to colliding resources; or resource reselection priority information.

In some implementations, the first rule includes at least one of the following:
the first communication device detects that a resource selected or reserved by the second communication device collides with the resource selected or reserved by the first communication device;
the first communication device detects that a resource selected or reserved by a third communication device collides with a resource selected or reserved by the second communication device;
the first communication device detects that an uplink transmission resource of the first communication device collides with a resource selected or reserved by the second communication device; or
the first communication device detects that an uplink transmission resource of a third communication device collides with a resource selected or reserved by the second communication device; where
the third communication device is another communication device except the first communication device.

In some implementations, the resource collision includes at least one of the following:
time domain resources partially or entirely overlap; or frequency domain resources partially or entirely overlap.

In some implementations, the collision type information of the resource collision includes at least one of the following:
collision caused by entire or partial overlapping between the resource selected or reserved by the second communication device and the resource selected or reserved by the third communication device;
collision caused by entire or partial overlapping between a PSFCH resource associated with the resource selected or reserved by the second communication device and a PSFCH resource associated with the resource selected or reserved by the third communication device;
collision caused by entire or partial overlapping between a PSFCH resource associated with the resource selected or reserved by the second communication device and the resource selected or reserved by the third communication device;
collision caused by entire or partial overlapping between the resource selected or reserved by the second communication device and a PSFCH resource associated with the resource selected or reserved by the third communication device;
collision caused by entire or partial overlapping between the resource selected or reserved by the second communication device and the uplink transmission resource of the third communication device;
collision caused by entire or partial overlapping between a PSFCH resource associated with the resource selected or reserved by the second communication device and the uplink transmission resource of the third communication device;
collision caused by entire or partial overlapping between the resource selected or reserved by the second communication device and a resource location selected or reserved by the first communication device to perform SL transmission;
collision caused by entire or partial overlapping between the resource selected or reserved by the second communication device and a resource location at which the first communication device performs UL transmission;
collision caused by entire or partial overlapping between a PSFCH resource associated with the resource selected or reserved by the second communication device and the resource selected or reserved by the first communication device;
collision caused by entire or partial overlapping between a PSFCH resource associated with the resource selected or reserved by the second communication device and a PSFCH resource associated with the resource selected or reserved by the first communication device;
collision caused by entire or partial overlapping between a PSFCH resource associated with the resource selected or reserved by the second communication device and an uplink UL transmission resource of the first communication device; or
collision caused by entire or partial overlapping between the resource selected or reserved by the second communication device and a PSFCH resource associated with the resource selected or reserved by the first communication device.

In some implementations, the location information of the resource collision includes at least one of the following:
some/all resources in the first N/K periods in the periodically reserved resources;
an M^{th} resource in the first N/K periods in the periodically reserved resources;
first/last M resources in the first N/K periods in the periodically reserved resources;
an M^{th} resource in aperiodically reserved resources;
all or some resources in aperiodically reserved resources; or
first/last M resources in aperiodically reserved resources; where

N, K, and M are positive integers.

In some implementations, the time validity feature information of the resource collision includes at least one of the following:
there is resource collision in a P^{th} period in periodically reserved resources;
there is resource collision in the first P periods in periodically reserved resources;
there is resource collision in the last P periods in periodically reserved resources;
there is a conflict in first preset duration after a current moment in periodically reserved resources;
there is a conflict in first preset duration after a current moment in aperiodically reserved resources;
there is resource collision in the first Q reserved resources in aperiodically reserved resources;
there is resource collision in the last Q reserved resources in aperiodically reserved resources; or
there is resource collision in a Q^{th} reserved resource in aperiodically reserved resources; where
both P and Q are positive integers.

In some implementations, the collision overlapping degree information of at least one colliding resource includes at least one of the following:
partial overlapping or entire overlapping;
a quantity of overlapping subchannels, a quantity of slots, a quantity of physical resource blocks, or a quantity of symbols;
a proportion of overlapping resources to a total quantity of resources reserved by the second communication device; or
a proportion of overlapping resources to current colliding resources reserved by the second communication device.

In some implementations, the transmission type information of the resource collision includes at least one of the following:
colliding resources are used for unicast transmission, multicast transmission, or broadcast transmission;
colliding resources are used to send data to a specific communication device or a specific group; or
colliding resources are used to send data to a control node.

In some implementations, the necessity degree information of the resource collision includes at least one of the following:
resource reselection that is necessary, that is suggested to be performed, that is suggested not to be performed, or that is unnecessary; or
a weight coefficient, where the weight coefficient is used to indicate a necessity degree of resource reselection.

In some implementations, the quantity or proportion information of the resource collision includes at least one of the following:
a quantity of colliding resources;
a proportion of colliding resources to a total quantity of resources reserved by the second communication device or a total quantity of resources reserved by the second communication device in at least one period;
a quantity of colliding resources in second preset duration; or
a proportion of colliding resources in second preset duration to a total quantity of resources reserved by the second communication device in the second preset duration or a total quantity of resources reserved by the second communication device in at least one period in the second preset duration; where
the quantity of colliding resources includes:
a quantity of colliding slots, subchannels, symbols, or physical resource blocks; and
the total quantity of reserved resources includes:
a total quantity of reserved slots, subchannels, symbols, or physical resource blocks.

In some implementations, the service priority information corresponding to colliding resources includes at least one of the following:
service priority information of a conflicting source device corresponding to the colliding resources;
a difference between a service priority of the second communication device and a service priority of a conflicting source device on the colliding resources or an absolute value of the difference; or
a relationship between a service priority of the second communication device and a service priority of a conflicting source device on the colliding resources; where
the conflicting source device is the first communication device or the third communication device.

In some implementations, the PSFCH resource occupies one or two symbols in time domain.

In a case that the PSFCH resource occupies two symbols in time domain, resources on the symbols are used to transmit different information.

In some implementations, the time domain resource location of the PSFCH resource is determined in at least one of the following manners:
determining the time domain resource location of the PSFCH resource based on a first slot/sub-frame in which Sidelink Control Information (SCI) sent by the second communication device to indicate a reserved resource is located;
determining the time domain resource location of the PSFCH resource based on a second slot/sub-frame in which a colliding resource reserved by the second communication device is located; or
determining the time domain resource location of the PSFCH resource based on a third slot/sub-frame in which a resource with no collision reserved by the second communication device is located.

In some implementations, the determining the time domain resource location of the PSFCH resource based on a first slot/sub-frame in which SCI sent by the second communication device to indicate a reserved resource is located includes at least one of the following:
in a case that there is a first PSFCH resource in the first slot/sub-frame, determining to transmit the first signaling by using the first PSFCH resource;
in a case that there is no PSFCH resource in the first slot/sub-frame, determining to transmit the first signaling by using a PSFCH resource that is nearest to the first slot/sub-frame;
transmitting the first signaling by using a PSFCH resource in an L^{th} slot/sub-frame after the first slot;
transmitting the first signaling by using a PSFCH resource that is nearest to an L^{th} slot/sub-frame after the first slot, where the nearest PSFCH resource is before or after the L^{th} slot/sub-frame after the first slot; or
transmitting the first signaling by using at least one PSFCH resource in third preset duration after the first slot; where
L is a positive integer.

In some implementations, the determining the time domain resource location of the PSFCH resource based on a second slot/sub-frame in which a colliding resource reserved by the second communication device is located includes at least one of the following:
transmitting the first signaling on a PSFCH resource in U slots/sub-frames before a second slot in which at least one colliding resource is located or in fourth preset duration;
transmitting the first signaling on a PSFCH resource that is nearest to a second slot in which at least one colliding resource is located;
transmitting the first signaling on a PSFCH resource that is before or after H slots/sub-frames before a second slot in which at least one colliding resource is located; or
selecting X PSFCH resources from R slots/sub-frames in R slots/sub-frames before a second slot in which at least one colliding resource is located or in fifth preset duration as a second PSFCH resource, and transmitting the first signaling on the second PSFCH resource; where
U, H, R, and X are positive integers.

In some implementations, the determining the time domain resource location of the PSFCH resource based on a third slot/sub-frame in which a resource with no collision reserved by the second communication device is located includes:
determining a resource for which collision occurs at the earliest time in all colliding resources, and determining nearest T reserved resources before the resource for which collision occurs at the earliest time;
determining a third PSFCH resource based on slots/sub-frames in which the T reserved resources are located, where the third PFSCH resource is in the slots in which the T reserved resources are located, or the third PSFCH resource is in a slot/sub-frame before slots/sub-frames in which the T reserved resources are located, or the third PSFCH resource is in a slot/sub-frame after slots/sub-frames in which the T reserved resources are located; and
transmitting the first signaling on the third PSFCH resource; where
T is a positive integer.

In some implementations, a frequency domain resource location of the PSFCH resource is determined in at least one of the following manners:
determining the frequency domain resource location of the PSFCH resource based on SCI sent by the second communication device to indicate a reserved resource;
determining the frequency domain resource location of the PSFCH resource based on a physical sidelink shared channel PSSCH associated with SCI sent by the second communication device to indicate a reserved resource;
determining the frequency domain resource location of the PSFCH resource based on a location on which a colliding resource reserved by the second communication device is located; or
determining the frequency domain resource location of the PSFCH resource based on a location on which a resource with no collision reserved by the second communication device is located.

In some implementations, the determining the frequency domain resource location of the PSFCH resource based on SCI sent by the second communication device to indicate a reserved resource includes:
determining the frequency domain resource location of the PSFCH resource by using a start, end, or center frequency domain resource of the SCI as a reference point.

In some implementations, the determining the frequency domain resource location of the PSFCH resource based on a PSSCH associated with SCI sent by the second communication device to indicate a reserved resource includes:
determining the frequency domain resource location of the PSFCH resource by using a start, end, or center frequency domain resource of the PSSCH as a reference point.

In some implementations, the determining the frequency domain resource location of the PSFCH resource based on a location on which a colliding resource reserved by the second communication device is located includes:
determining the frequency domain resource location of the PSFCH resource by using a start, end, or center frequency domain resource of the colliding resource as a reference point.

In some implementations, the determining the frequency domain resource location of the PSFCH resource based on a location on which a resource with no collision reserved by the second communication device is located includes at least one of the following:
determining the frequency domain resource location of the PSFCH resource by using a start, end, or center frequency domain resource of an earliest resource with no collision as a reference point;
determining the frequency domain resource location of the PSFCH resource by using a start, end, or center frequency domain resource of a resource with no collision before an earliest colliding resource as a reference point; or
determining the frequency domain resource location of the PSFCH resource by using a start, end, or center frequency domain resource of any resource with no collision as a reference point.

In some implementations, the PSFCH resource occupies one or more PRBs in frequency domain.

In some implementations, in a case that the PSFCH resource occupies one PRB in frequency domain, at least one of the following is met:
each code point of the first signaling corresponds to at least one information meaning, each information meaning corresponds to at least one M_CS value, each M_CS value corresponds to one cyclic prefix index value/cyclic prefix, first spacings between cyclic prefix index values/cyclic prefixes corresponding to each M_CS value are the same, and the first spacing is configured by a network side/higher layer;
a default code point configured by a network side/higher layer is obtained as a reference code point for demodulating the first signaling, where the reference code point corresponds to one default state, and the reference code point corresponds to one configured M_CS value;
an amount of first signaling or a quantity of PSFCHs transmitted by a same communication device supported by each PRB configured by a network side/higher layer is obtained;
a quantity of cyclic prefix pairs supported by each PRB configured by a network side/higher layer is obtained;
an amount of transmitted first signaling or a quantity of transmitted PSFCHs supported by each PRB configured by a network side/higher layer is obtained;
a start index value of a cyclic prefix pair corresponding to each PRB configured by a network side/higher layer is obtained; or
a quantity of communication devices that are supported by each PRB configured by a network side/higher layer for sending the first signaling is received.

In some implementations, in a case that the PSFCH resource occupies a plurality of PRBs in frequency domain, at least one of the following is met:
each code point of the first signaling corresponds to at least one information meaning, each information meaning corresponds to at least one M_CS value, and each M_CS value corresponds to one cyclic prefix index value/cyclic prefix;
each PRB is associated with at least one code point;
the PRBs carry different information, and each PRB is associated with at least one type of indication information;
an amount of first signaling or a quantity of PSFCHs transmitted by a same communication device supported by every W PRBs configured by a network side/higher layer is obtained;
a quantity of cyclic prefix pairs supported by every W PRBs configured by a network side/higher layer is obtained;
an amount of first signaling or a quantity of transmitted PSFCHs supported by every W PRBs configured by a network side/higher layer is obtained;
a start index value of a cyclic prefix pair corresponding to every W PRBs configured by a network side/higher layer is obtained;
a quantity of communication devices that are supported by every W PRBs configured by a network side/higher layer for sending the first signaling is received;
on a same PRB, second spacings between cyclic prefix index values/cyclic prefixes corresponding to M_CS values are the same, where the second spacing is configured by a network side/higher layer; or
a default code point configured by a network side/higher layer is obtained as a reference code point for demodulating the first signaling, where the reference code point corresponds to one default state, and the reference code point corresponds to one configured M_CS value; where
W is a positive integer.

In some implementations, the multiplexing manner of the PSFCH resource includes at least one of the following:
a frequency division multiplexing manner;
a code division multiplexing manner; or
a time division multiplexing manner.

In some implementations, the frequency division multiplexing manner meets at least one of the following:
communication devices use different PRBs on the PFSCH when transmitting the first signaling; or
PRBs used by different communication devices to transmit the first signaling are consecutive or discrete on the PSFCH.

In some implementations, the code division multiplexing manner meets at least one of the following:
first signaling transmission or PSFCH transmission of a plurality of communication devices is multiplexed on a same PRB or a plurality of PRBs;
a quantity of cyclic prefix pairs supported by every V PRBs configured by a network side/higher layer is obtained;
an amount of first signaling or a quantity of PSFCHs from different communication devices supported by every V PRBs configured by a network side/higher layer is obtained;
a start index value of a cyclic prefix pair corresponding to code points of first signaling of different communication devices supported by every V PRBs configured by a network side/higher layer is obtained;
M_CS values corresponding to code points of first signaling of different communication devices supported by every V PRBs configured by a network side/higher layer is obtained, where each M_CS value corresponds to one cyclic prefix index value, and an M_CS value corresponding to a code point of first signaling of a same communication device comes from a same cyclic prefix pair;
a quantity of communication devices that are supported by every V PRBs configured by a network side/higher layer for sending the first signaling is received; or
on every V PRBs, third spacings between cyclic prefix index values/cyclic prefixes corresponding to M_CS values of different communication devices keep the same, where the third spacing is configured by a network side/higher layer; where
V is a positive integer.

In some implementations, the time division multiplexing manner meets at least one of the following:
first signaling of different communication devices is transmitted by using resources on different symbols;
first signaling of a same communication device is transmitted by using resources on a plurality of symbols, and information transmitted on different symbols is different; or
first signaling of a same communication device is transmitted by using resources on a plurality of symbols, and information transmitted on different symbols is the same.

In some implementations, a sequence length of the PSFCH resource, a sequence length for transmitting the PSFCH, or a sequence length for transmitting the first signaling is determined by using one of the following:
a quantity of code points or indication states corresponding to transmission of the first signaling;
a quantity of corresponding code points or a quantity of indication states when transmission of the first signaling by a plurality of communication devices is multiplexed on Y PRBs;
a quantity of code points corresponding to at least one PRB during transmission of the first signaling; or
a quantity of code points or a quantity of indication states on at least one PRB when transmission of the first signaling by a plurality of communication devices is multiplexed on Y PRBs; where
Y is a positive integer.

In some implementations, the configuration manner of the PSFCH resource includes at least one of the following:
being configured in units of resource pools;
being configured in units of BWPs;
being configured in units of system bandwidth;
being independently configured for one or more transmission types;
being uniformly configured for a plurality of transmission types, and state interpretation of the PSFCH resource needs to be independently defined for one or some transmission types;
being independently configured for a resource collision type; or
being independently configured for a HARQ feedback manner.

In this embodiment of this application, content carried in the reselection indication signaling, an expressed meaning, and the configuration manner and the multiplexing manner of the PSFCH resource are provided, and content such as a resource location occupied when at least one first communication device sends the resource reselection indication signaling, a quantity, and a multiplexing manner can be determined, thereby effectively resolving a problem of using the PSFCH to transmit the resource reselection indication, improving transmission efficiency in a sidelink system, reducing signaling overheads, and improving system performance.

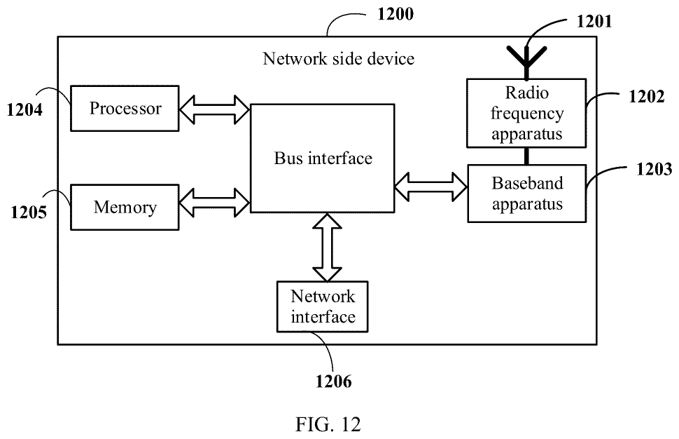

In some implementations, an embodiment of this application further provides a second communication device. As shown in FIG. 12, the second communication device 1200 includes an antenna 1201, a radio frequency apparatus 1202, and a baseband apparatus 1203. The antenna 1201 is connected to the radio frequency apparatus 1202. In an uplink direction, the radio frequency apparatus 1202 receives information by using the antenna 1201, and sends the received information to the baseband apparatus 1203 for processing. In a downlink direction, the baseband apparatus 1203 processes information that needs to be sent, and sends processed information to the radio frequency apparatus 1202. The radio frequency apparatus 1202 processes the received information, and sends processed information by using the antenna 1201.

The frequency band processing apparatus may be located in the baseband apparatus 1203. The method performed by the second communication device in the foregoing embodiment may be implemented in the baseband apparatus 1203. The baseband apparatus 1203 includes a processor 1204 and a memory 1205.

The baseband apparatus 1203 may include, for example, at least one baseband board, where a plurality of chips are disposed on the baseband board. As shown in FIG. 12, one chip is, for example, the processor 1204, which is connected to the memory 1205, so as to invoke a program in the memory 1205 to perform operations of the network side device shown in the foregoing method embodiment.

The baseband apparatus 1203 may further include a network interface 1206, configured to exchange information with the radio frequency apparatus 1202. For example, the interface is a Common Public Radio Interface (CPRI for short).

In some implementations, the second communication device in this embodiment of the present disclosure further includes an instruction or a program stored in the memory 1205 and executable on the processor 1204. The processor 1204 invokes the instruction or the program in the memory 1205 to perform the method performed by the modules shown in FIG. 8, and a same technical effect is achieved. To avoid repetition, details are not described herein again.

An embodiment of this application further provides a second communication device, including a processor and a communication interface. The communication interface is configured to receive first signaling on a physical sidelink feedback channel PSFCH resource, where the first signaling is used to instruct the second communication device to perform resource reselection, and the first signaling carries at least one of the following information: information about whether to perform resource reselection; collision type information of resource collision; location information of resource collision; time validity feature information of resource collision; collision overlapping degree information of at least one colliding resource; transmission type information of resource collision; necessity degree information of resource reselection; quantity or proportion information of resource collision; service priority information corresponding to colliding resources; or resource reselection priority information. This embodiment of the second communication device is corresponding to the foregoing method embodiment of the second communication device side. Each implementation process and implementation manner of the foregoing method embodiment may be applicable to this embodiment of the second communication device, and a same technical effect can be achieved.

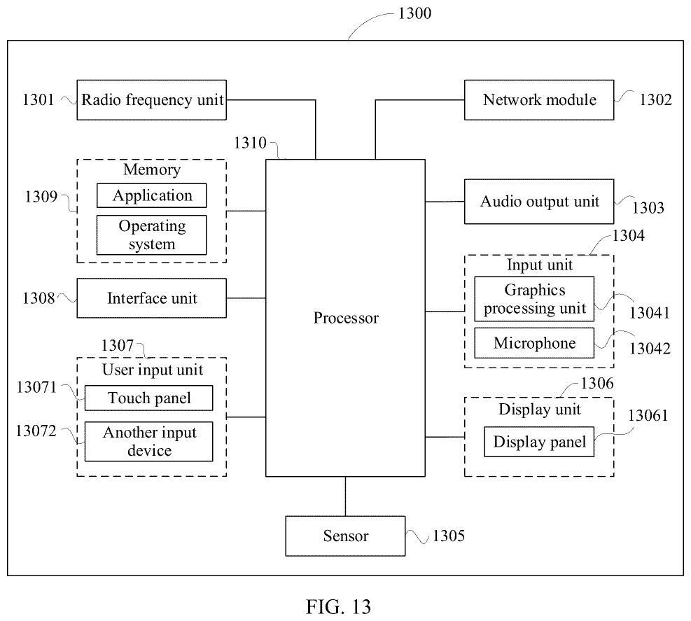

FIG. 13 is a schematic diagram of a structure of a second communication device for implementing embodiments of this application.

The terminal 1300 includes but is not limited to at least a part of components such as a radio frequency unit 1301, a network module 1302, an audio output unit 1303, an input unit 1304, a sensor 1305, a display unit 1306, a user input unit 1307, an interface unit 1308, a memory 1309, and a processor 1310.

It may be understood by a person skilled in the art that the second communication device 1300 may further include a power supply (such as a battery) that supplies power to each component. The power supply may be logically connected to the processor 1310 by using a power management system, to implement functions such as charging, discharging, and power consumption management by using the power management system. The terminal structure shown in FIG. 13 constitutes no limitation on the terminal, and the terminal may include more or fewer components than those shown in the figure, or combine some components, or have different component arrangements. Details are not described herein.

It should be understood that in this embodiment of this application, the input unit 1304 may include a Graphics Processing Unit (GPU) 13041 and a microphone 13042. The graphics processing unit 13041 processes image data of a static picture or a video obtained by an image capture apparatus (for example, a camera) in a video capture mode or an image capture mode. The display unit 1306 may include a display panel 13061. In some implementations, the display panel 13061 may be configured in a form such as a liquid crystal display or an organic light-emitting diode. The user input unit 1307 includes a touch panel 13071 and another input device 13072. The touch panel 13071 is also referred to as a touchscreen. The touch panel 13071 may include two parts: a touch detection apparatus and a touch controller. The another input device 13072 may include but is not limited to a physical keyboard, a functional button (such as a volume control button or a power on/off button), a trackball, a mouse, and a joystick. Details are not described herein.

In this embodiment of this application, the radio frequency unit 1301 receives downlink data from a network side device and then sends the downlink data to the processor 1310 for processing; and sends uplink data to the network side device. Usually, the radio frequency unit 1301 includes but is not limited to an antenna, at least one amplifier, a transceiver, a coupler, a low noise amplifier, a duplexer, and the like.

The memory 1309 may be configured to store a software program or an instruction and various data. The memory 1309 may mainly include a program or instruction storage area and a data storage area. The program or instruction storage area may store an operating system, an application or an instruction required by at least one function (for example, a sound playing function or an image playing function), and the like. In addition, the memory 1309 may include a high-speed random access memory, and may further include a non-volatile memory. The non-volatile memory may be a Read-Only Memory (ROM), a Programmable ROM (PROM), an Erasable PROM (EPROM), an Electrically EPROM (EEPROM), or a flash memory, for example, at least one disk storage device, a flash memory device, or another non-volatile solid-state storage device.

The processor 1310 may include one or more processing units. In some implementations, an application processor and a modem processor may be integrated into the processor 1310. The application processor mainly processes an operating system, a user interface, an application, an instruction, or the like. The modem processor mainly processes wireless communication, for example, a baseband processor. It may be understood that, the modem processor may alternatively not be integrated into the processor 1310.

The radio frequency unit 1301 is configured to receive first signaling on a PSFCH resource, where the first signaling is used to instruct the second communication device to perform resource reselection, and the first signaling carries at least one of the following information: information about whether to perform resource reselection; collision type information of resource collision; location information of resource collision; time validity feature information of resource collision; collision overlapping degree information of at least one colliding resource; transmission type information of resource collision; necessity degree information of resource reselection; quantity or proportion information of resource collision; service priority information corresponding to colliding resources; or resource reselection priority information.

In some implementations, the PSFCH resource occupies one or two symbols in time domain; where
in a case that the PSFCH resource occupies two symbols in time domain, resources on the symbols are used to transmit different information.

In some implementations, the PSFCH resource occupies one or more PRBs in frequency domain.

In some implementations, in a case that the PSFCH resource occupies one PRB in frequency domain, at least one of the following is met:
each code point of the first signaling corresponds to at least one information meaning, each information meaning corresponds to at least one M_CS value, each M_CS value corresponds to one cyclic prefix index value/cyclic prefix, first spacings between cyclic prefix index values/cyclic prefixes corresponding to each M_CS value are the same, and the first spacing is configured by a network side/higher layer;
a default code point configured by a network side/higher layer is obtained as a reference code point for demodulating the first signaling, where the reference code point corresponds to one default state, and the reference code point corresponds to one configured M_CS value;
an amount of first signaling or a quantity of PSFCHs transmitted by a same communication device supported by each PRB configured by a network side/higher layer is obtained;
a quantity of cyclic prefix pairs supported by each PRB configured by a network side/higher layer is obtained;
an amount of transmitted first signaling or a quantity of transmitted PSFCHs supported by each PRB configured by a network side/higher layer is obtained;
a start index value of a cyclic prefix pair corresponding to each PRB configured by a network side/higher layer is obtained; or
a quantity of communication devices that are supported by each PRB configured by a network side/higher layer for sending the first signaling is received.

In some implementations, in a case that the PSFCH resource occupies a plurality of PRBs in frequency domain, at least one of the following is met:
each code point of the first signaling corresponds to at least one information meaning, each information meaning corresponds to at least one M_CS value, and each M_CS value corresponds to one cyclic prefix index value/cyclic prefix;
each PRB is associated with at least one code point;
the PRBs carry different information, and each PRB is associated with at least one type of indication information;
an amount of first signaling or a quantity of PSFCHs transmitted by a same communication device supported by every W PRBs configured by a network side/higher layer is obtained;
a quantity of cyclic prefix pairs supported by every W PRBs configured by a network side/higher layer is obtained;
an amount of first signaling or a quantity of transmitted PSFCHs supported by every W PRBs configured by a network side/higher layer is obtained;
a start index value of a cyclic prefix pair corresponding to every W PRBs configured by a network side/higher layer is obtained;
a quantity of communication devices that are supported by every W PRBs configured by a network side/higher layer for sending the first signaling is received;
on a same PRB, second spacings between cyclic prefix index values/cyclic prefixes corresponding to M_CS values are the same, where the second spacing is configured by a network side/higher layer; or
a default code point configured by a network side/higher layer is obtained as a reference code point for demodulating the first signaling, where the reference code point corresponds to one default state, and the reference code point corresponds to one configured M_CS value; where
W is a positive integer.

In some implementations, the multiplexing manner of the PSFCH resource includes at least one of the following:
a frequency division multiplexing manner;
a code division multiplexing manner; or
a time division multiplexing manner.

In some implementations, the frequency division multiplexing manner meets at least one of the following:
communication devices use different PRBs on the PFSCH when transmitting the first signaling; or
PRBs used by different communication devices to transmit the first signaling are consecutive or discrete on the PSFCH.

In some implementations, the code division multiplexing manner meets at least one of the following:
first signaling transmission or PSFCH transmission of a plurality of communication devices is multiplexed on a same PRB or a plurality of PRBs;
a quantity of cyclic prefix pairs supported by every V PRBs configured by a network side/higher layer is obtained;
an amount of first signaling or a quantity of PSFCHs from different communication devices supported by every V PRBs configured by a network side/higher layer is obtained;
a start index value of a cyclic prefix pair corresponding to code points of first signaling of different communication devices supported by every V PRBs configured by a network side/higher layer is obtained;
M_CS values corresponding to code points of first signaling of different communication devices supported by every V PRBs configured by a network side/higher layer is obtained, where each M_CS value corresponds to one cyclic prefix index value, and an M_CS value corresponding to a code point of first signaling of a same communication device comes from a same cyclic prefix pair;
a quantity of communication devices that are supported by every V PRBs configured by a network side/higher layer for sending the first signaling is received; or
on every V PRBs, third spacings between cyclic prefix index values/cyclic prefixes corresponding to M_CS values of different communication devices keep the same, where the third spacing is configured by a network side/higher layer; where
V is a positive integer.

In some implementations, the time division multiplexing manner meets at least one of the following:
first signaling of different communication devices is transmitted by using resources on different symbols;
first signaling of a same communication device is transmitted by using resources on a plurality of symbols, and information transmitted on different symbols is different; or
first signaling of a same communication device is transmitted by using resources on a plurality of symbols, and information transmitted on different symbols is the same.

In some implementations, a sequence length of the PSFCH resource, a sequence length for transmitting the PSFCH, or a sequence length for transmitting the first signaling is determined by using one of the following:
a quantity of code points or indication states corresponding to transmission of the first signaling;
a quantity of corresponding code points or a quantity of indication states when transmission of the first signaling by a plurality of communication devices is multiplexed on Y PRBs;
a quantity of code points corresponding to at least one PRB during transmission of the first signaling; or
a quantity of code points or a quantity of indication states on at least one PRB when transmission of the first signaling by a plurality of communication devices is multiplexed on Y PRBs; where
Y is a positive integer.

In some implementations, the configuration manner of the PSFCH resource includes at least one of the following:
being configured in units of resource pools;
being configured in units of BWPs;
being configured in units of system bandwidth;
being independently configured for one or more transmission types;
being uniformly configured for a plurality of transmission types, and state interpretation of the PSFCH resource needs to be independently defined for one or some transmission types;
being independently configured for a resource collision type; or
being independently configured for a HARQ feedback manner.

In this embodiment of this application, content carried in the reselection indication signaling, an expressed meaning, and the configuration manner and the multiplexing manner of the PSFCH resource are provided, and content such as a resource location occupied when at least one first communication device sends the resource reselection indication signaling, a quantity, and a multiplexing manner can be determined, thereby effectively resolving a problem of using the PSFCH to transmit the resource reselection indication, improving transmission efficiency in a sidelink system, reducing signaling overheads, and improving system performance.

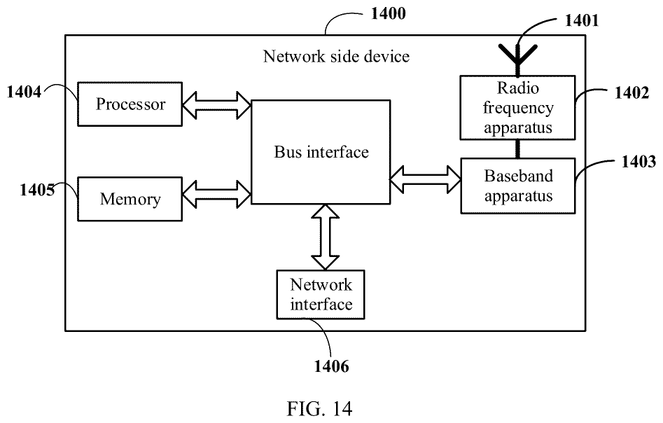

In some implementations, an embodiment of this application further provides a second communication device. As shown in FIG. 14, the second communication device 1400 includes an antenna 1401, a radio frequency apparatus 1402, and a baseband apparatus 1403. The antenna 1401 is connected to the radio frequency apparatus 1402. In an uplink direction, the radio frequency apparatus 1402 receives information by using the antenna 1401, and sends the received information to the baseband apparatus 1403 for processing. In a downlink direction, the baseband apparatus 1403 processes information that needs to be sent, and sends processed information to the radio frequency apparatus 1402. The radio frequency apparatus 1402 processes the received information, and sends processed information by using the antenna 1401.

The frequency band processing apparatus may be located in the baseband apparatus 1403. The method performed by the second communication device in the foregoing embodiment may be implemented in the baseband apparatus 1403. The baseband apparatus 1403 includes a processor 1404 and a memory 1405.

The baseband apparatus 1403 may include, for example, at least one baseband board, where a plurality of chips are disposed on the baseband board. As shown in FIG. 14, one chip is, for example, the processor 1404, which is connected to the memory 1405, so as to invoke a program in the memory 1405 to perform operations of the network side device shown in the foregoing method embodiment.

The baseband apparatus 1403 may further include a network interface 1406, configured to exchange information with the radio frequency apparatus 1402. For example, the interface is a CPRI.

In some implementations, the second communication device in this embodiment of the present disclosure further includes an instruction or a program stored in the memory 1405 and executable on the processor 1404. The processor 1404 invokes the instruction or the program in the memory 1405 to perform the method performed by the modules shown in FIG. 9, and a same technical effect is achieved. To avoid repetition, details are not described herein again.

An embodiment of this application further provides a non-transitory readable storage medium. The readable storage medium stores a program or an instruction, and when the program or the instruction is executed by a processor, the processes of the embodiment of the foregoing physical sidelink feedback channel resource configuration method are implemented, and a same technical effect can be achieved. To avoid repetition, details are not described herein again.

The processor is a processor in the terminal in the foregoing embodiments. The readable storage medium includes a computer-readable storage medium, such as a computer Read-Only Memory (ROM), a Random Access Memory (RAM), a magnetic disk, or an optical disc.

An embodiment of the present application further provides a chip, the chip includes a processor and a communication interface, the communication interface is coupled to the processor, and the processor is configured to run a program or an instruction to implement the processes of the foregoing embodiment of the physical sidelink feedback channel resource configuration method and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product, the computer program/program product is stored in a non-transient storage medium, and the computer program/program product is executed by at least one processor to implement the processes of the foregoing embodiments of the method for reporting a system message report, and a same technical effect can be achieved. To avoid repetition, details are not described herein again.

It should be noted that, in this specification, the term “include,” “comprise,” or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. Based on such an understanding, the technical solutions of this application essentially or the part contributing to the related art may be implemented in a form of a computer software product. The computer software product is stored in a storage medium (such as a ROM/RAM, a hard disk, or an optical disc), and includes several instructions for instructing a terminal (which may be mobile phone, a computer, a server, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A Physical Sidelink Feedback CHannel (PSFCH) resource configuration method, comprising:
sending, by a first communication device, first signaling to a second communication device by using a PSFCH resource according to a first rule, wherein the first signaling is used to instruct the second communication device to perform resource reselection; wherein
the first signaling carries at least one of the following information:
information about whether to perform resource reselection;
collision type information of resource collision;
location information of resource collision;
time validity feature information of resource collision;
collision overlapping degree information of at least one colliding resource;
transmission type information of resource collision;
necessity degree information of resource reselection;
quantity or proportion information of resource collision;
service priority information corresponding to colliding resources; or
resource reselection priority information.

2. The PSFCH resource configuration method according to claim 1, wherein the collision type information of the resource collision comprises at least one of the following:
collision caused by entire or partial overlapping between the resource selected or reserved by the second communication device and the resource selected or reserved by the third communication device;
collision caused by entire or partial overlapping between the PSFCH resource associated with the resource selected or reserved by the second communication device and the PSFCH resource associated with the resource selected or reserved by the third communication device;
collision caused by entire or partial overlapping between the PSFCH resource associated with the resource selected or reserved by the second communication device and the resource selected or reserved by the third communication device;
collision caused by entire or partial overlapping between the resource selected or reserved by the second communication device and the PSFCH resource associated with the resource selected or reserved by the third communication device;
collision caused by entire or partial overlapping between the resource selected or reserved by the second communication device and the uplink transmission resource of the third communication device;
collision caused by entire or partial overlapping between the PSFCH resource associated with the resource selected or reserved by the second communication device and the uplink transmission resource of the third communication device;
collision caused by entire or partial overlapping between the resource selected or reserved by the second communication device and a resource location selected or reserved by the first communication device to perform SideLink (SL) transmission;
collision caused by entire or partial overlapping between the resource selected or reserved by the second communication device and a resource location at which the first communication device performs UpLink (UL) transmission;
collision caused by entire or partial overlapping between the PSFCH resource associated with the resource selected or reserved by the second communication device and the resource selected or reserved by the first communication device;
collision caused by entire or partial overlapping between the PSFCH resource associated with the resource selected or reserved by the second communication device and the PSFCH resource associated with the resource selected or reserved by the first communication device;
collision caused by entire or partial overlapping between the PSFCH resource associated with the resource selected or reserved by the second communication device and an uplink UL transmission resource of the first communication device; or
collision caused by entire or partial overlapping between the resource selected or reserved by the second communication device and the PSFCH resource associated with the resource selected or reserved by the first communication device.

3. The PSFCH resource configuration method according to claim 1, wherein the location information of the resource collision comprises at least one of the following:
some or all resources in the first N or K periods in the periodically reserved resources;
an M^{th} resource in the first N or K periods in the periodically reserved resources;
first or last M resources in the first N or K periods in the periodically reserved resources;
an M^{th} resource in aperiodically reserved resources;
all or some resources in aperiodically reserved resources; or
first or last M resources in aperiodically reserved resources; wherein
N, K, and M are positive integers.

4. The PSFCH resource configuration method according to claim 1, wherein a time domain resource location of the PSFCH resource is determined in at least one of the following manners:
determining the time domain resource location of the PSFCH resource based on a first slot or a first sub-frame in which Sidelink Control Information (SCI) sent by the second communication device to indicate a reserved resource is located;
determining the time domain resource location of the PSFCH resource based on a second slot or a second sub-frame in which a colliding resource reserved by the second communication device is located; or
determining the time domain resource location of the PSFCH resource based on a third slot or a third sub-frame in which a resource with no collision reserved by the second communication device is located.

5. The PSFCH resource configuration method according to claim 4, wherein the determining the time domain resource location of the PSFCH resource based on a first slot or a first sub-frame in which SCI sent by the second communication device to indicate a reserved resource is located comprises at least one of the following:
when there is a first PSFCH resource in the first slot or the first sub-frame, determining to transmit the first signaling by using the first PSFCH resource;
when there is no PSFCH resource in the first slot or the first sub-frame, determining to transmit the first signaling by using a PSFCH resource that is nearest to the first slot or the first sub-frame;
transmitting the first signaling by using a PSFCH resource in an L^{th} slot or an L^{th} sub-frame after the first slot;
transmitting the first signaling by using the PSFCH resource that is nearest to the L^{th} slot or the L^{th} sub-frame after the first slot, wherein the nearest PSFCH resource is before or after the L^{th} slot or the L^{th} sub-frame after the first slot; or
transmitting the first signaling by using at least one PSFCH resource in third preset duration after the first slot; wherein L is a positive integer.

6. The PSFCH resource configuration method according to claim 4, wherein the determining the time domain resource location of the PSFCH resource based on a second slot or a second sub-frame in which a colliding resource reserved by the second communication device is located comprises at least one of the following:
transmitting the first signaling on the PSFCH resource in U slots or U sub-frames before the second slot in which at least one colliding resource is located or in fourth preset duration;
transmitting the first signaling on the PSFCH resource that is nearest to the second slot in which at least one colliding resource is located;
transmitting the first signaling on the PSFCH resource that is before or after H slots or H sub-frames before the second slot in which at least one colliding resource is located; or
selecting X PSFCH resources from R slots or R sub-frames before the second slot in which at least one colliding resource is located or in fifth preset duration as a second PSFCH resource, and transmitting the first signaling on the second PSFCH resource; wherein
U, H, R, and X are positive integers.

7. The PSFCH resource configuration method according to claim 1, wherein a configuration manner of the PSFCH resource comprises at least one of the following:
being configured in units of resource pools;
being configured in units of Bandwidth Parts (BWPs);
being configured in units of system bandwidth;
being independently configured for one or more transmission types;
being uniformly configured for a plurality of transmission types, and state interpretation of the PSFCH resource needs to be independently defined for one or some transmission types;
being independently configured for a resource collision type; or
being independently configured for a Hybrid Automatic Repeat reQuest (HARQ) feedback manner.

8. A Physical Sidelink Feedback CHannel (PSFCH) resource configuration method, comprising:
receiving, by a second communication device, first signaling on a PSFCH resource, wherein the first signaling is used to instruct the second communication device to perform resource reselection; wherein
the first signaling carries at least one of the following information:
information about whether to perform resource reselection;
collision type information of resource collision;
location information of resource collision;
time validity feature information of resource collision;
collision overlapping degree information of at least one colliding resource;
transmission type information of resource collision;
necessity degree information of resource reselection;
quantity or proportion information of resource collision;
service priority information corresponding to colliding resources; or
resource reselection priority information.

9. The PSFCH resource configuration method according to claim 8, wherein the PSFCH resource occupies one or two symbols in time domain; and
in a case that the PSFCH resource occupies two symbols in time domain, resources on the symbols are used to transmit different information.

10. The PSFCH resource configuration method according to claim 8, wherein the PSFCH resource occupies one or more Physical Resource Blocks (PRBs) in frequency domain.

11. The PSFCH resource configuration method according to claim 10, wherein in a case that the PSFCH resource occupies one PRB in frequency domain, at least one of the following is met:
each code point of the first signaling corresponds to at least one information meaning, each information meaning corresponds to at least one M_CS value, each M_CS value corresponds to one cyclic prefix index value or cyclic prefix, first spacings between cyclic prefix index values or cyclic prefixes corresponding to each M_CS value are the same, and the first spacing is configured by a network side or a higher layer;
a default code point configured by a network side or a higher layer is obtained as a reference code point for demodulating the first signaling, wherein the reference code point corresponds to one default state, and the reference code point corresponds to one configured M_CS value;
an amount of first signaling or a quantity of PSFCHs transmitted by a same communication device supported by each PRB configured by a network side or a higher layer is obtained;
a quantity of cyclic prefix pairs supported by each PRB configured by a network side or a higher layer is obtained;
an amount of transmitted first signaling or a quantity of transmitted PSFCHs supported by each PRB configured by a network side or a higher layer is obtained;
a start index value of a cyclic prefix pair corresponding to each PRB configured by a network side or a higher layer is obtained; or
a quantity of communication devices that are supported by each PRB configured by a network side or a higher layer for sending the first signaling is received.

12. The PSFCH resource configuration method according to claim 10, wherein in a case that the PSFCH resource occupies a plurality of PRBs in frequency domain, at least one of the following is met:
each code point of the first signaling corresponds to at least one information meaning, each information meaning corresponds to at least one M_CS value, and each M_CS value corresponds to one cyclic prefix index value or one cyclic prefix;
each PRB is associated with at least one code point;
the PRBs carry different information, and each PRB is associated with at least one type of indication information;
an amount of first signaling or a quantity of PSFCHs transmitted by a same communication device supported by every W PRBs configured by a network side or a higher layer is obtained;
a quantity of cyclic prefix pairs supported by every W PRBs configured by a network side or a higher layer is obtained;
an amount of first signaling or a quantity of transmitted PSFCHs supported by every W PRBs configured by a network side or a higher layer is obtained;
a start index value of a cyclic prefix pair corresponding to every W PRBs configured by a network side or a higher layer is obtained;
a quantity of communication devices that are supported by every W PRBs configured by a network side or a higher layer for sending the first signaling is received;
on a same PRB, second spacings between cyclic prefix index values or cyclic prefixes corresponding to M_CS values are the same, wherein the second spacing is configured by a network side or a higher layer; or
a default code point configured by a network side or a higher layer is obtained as a reference code point for demodulating the first signaling, wherein the reference code point corresponds to one default state, and the reference code point corresponds to one configured M_CS value; wherein
W is a positive integer.

13. The PSFCH resource configuration method according to claim 8, wherein a multiplexing manner of the PSFCH resource comprises at least one of the following:
a frequency division multiplexing manner;
a code division multiplexing manner; or
a time division multiplexing manner.

14. The PSFCH resource configuration method according to claim 13, wherein the frequency division multiplexing manner meets at least one of the following:
communication devices use different PRBs on the PFSCH when transmitting the first signaling; or
PRBs used by different communication devices to transmit the first signaling are consecutive or discrete on the PSFCH.

15. The PSFCH resource configuration method according to claim 13, wherein the code division multiplexing manner meets at least one of the following:
first signaling transmission or PSFCH transmission of a plurality of communication devices is multiplexed on a same PRB or a plurality of PRBs;
a quantity of cyclic prefix pairs supported by every V PRBs configured by a network side or a higher layer is obtained;
an amount of first signaling or a quantity of PSFCHs from different communication devices supported by every V PRBs configured by a network side or a higher layer is obtained;
a start index value of a cyclic prefix pair corresponding to code points of first signaling of different communication devices supported by every V PRBs configured by a network side or a higher layer is obtained;
M_CS values corresponding to code points of first signaling of different communication devices supported by every V PRBs configured by a network side or a higher layer is obtained, wherein each M_CS value corresponds to one cyclic prefix index value, and an M_CS value corresponding to a code point of first signaling of a same communication device comes from a same cyclic prefix pair;
a quantity of communication devices that are supported by every V PRBs configured by a network side or a higher layer for sending the first signaling is received; or
on every V PRBs, third spacings between cyclic prefix index values or cyclic prefixes corresponding to M_CS values of different communication devices keep the same, wherein the third spacing is configured by a network side or a higher layer; wherein
V is a positive integer.

16. The PSFCH resource configuration method according to claim 13, wherein the time division multiplexing manner meets at least one of the following:
first signaling of different communication devices is transmitted by using resources on different symbols;
first signaling of a same communication device is transmitted by using resources on a plurality of symbols, and information transmitted on different symbols is different; or
first signaling of a same communication device is transmitted by using resources on a plurality of symbols, and information transmitted on different symbols is the same.

17. The PSFCH resource configuration method according to claim 8, wherein a sequence length of the PSFCH resource, a sequence length for transmitting the PSFCH, or a sequence length for transmitting the first signaling is determined by using at least one of the following:
a quantity of code points or indication states corresponding to transmission of the first signaling;
a quantity of corresponding code points or a quantity of indication states when transmission of the first signaling by a plurality of communication devices is multiplexed on Y Physical Resource Blocks (PRBs);
a quantity of code points corresponding to at least one PRB during transmission of the first signaling; or
a quantity of code points or a quantity of indication states on at least one PRB when transmission of the first signaling by a plurality of communication devices is multiplexed on Y PRBs; wherein
Y is a positive integer.

18. The PSFCH resource configuration method according to claim 8, wherein a configuration manner of the PSFCH resource comprises at least one of the following:
being configured in units of resource pools;
being configured in units of Bandwidth Parts (BWPs);
being configured in units of system bandwidth;
being independently configured for one or more transmission types;
being uniformly configured for a plurality of transmission types, and state interpretation of the PSFCH resource needs to be independently defined for one or some transmission types;
being independently configured for a resource collision type; or
being independently configured for a Hybrid Automatic Repeat reQuest (HARQ) feedback manner.

19. A first communication device, comprising:
a processor;
a memory; and
a program or an instruction that is stored in the memory and that is run on the processor, wherein the program or the instruction is executed by the processor to implement the physical sidelink feedback channel resource configuration method according to claim 1.

20. A second communication device, comprising:
a processor;
a memory; and
a program or an instruction that is stored in the memory and that is run on the processor, wherein the program or the instruction is executed by the processor to implement the physical sidelink feedback channel resource configuration method according to claim 8.
